(19) United States
(12) Patent Application Publication
(10) Pub. No.: US 2022/0414722 A1
(43) Pub. Date: Dec. 29, 2022

(54) Valuation Method, Pricing Method, Apparatus and System for Cloud Product

(71) Applicant: Beijing Kingsoft Cloud Network Technology Co., Ltd., Beijing (CN)

(72) Inventors: Jianting Zhu, Beijing (CN); Hetong Chen, Beijing (CN); Yu Chen, Beijing (CN)

(21) Appl. No.: 17/753,532

(22) PCT Filed: Dec. 8, 2020
(86) PCT No.: PCT/CN2020/134460

§ 371 Date: Mar. 7, 2022

(30) Foreign Application Priority Data
Dec. 20, 2019 (CN) 201911326550.1
Dec. 20, 2019 (CN) 201911329475.4

(51) Int. Cl. G06Q 30/02; G06Q 30/06

(52) U.S. Cl. CPC G06Q 30/0283; G06Q 30/0625

(57) ABSTRACT

A valuation method, pricing method, apparatus and system for a cloud product. The method comprises: obtaining a value of a target billing item of a to-be-valued product and values of impact factors of the target billing item, the impact factors of the target billing item correspond to the target billing item; determining a comprehensive factor corresponding to the target billing item using the values of the impact factors of the target billing item; querying, according to the comprehensive factor corresponding to the target billing item, pricing information of the target billing item from a preset first-type mapping relationship regarding billing items, comprehensive factors, and the pricing information; and calculating a valuation fee for the to-be-valued product using the value and pricing information of the target billing item.

The present application claims the priority to a Chinese patent application No. 201911329475.4 filed with the China National Intellectual Property Administration on Dec. 20, 2019 and entitled “Valuation Method, Pricing Method, Apparatus And System For Cloud Product”, a Chinese patent application No. 201911326550.1 filed with the China National Intellectual Property Administration on Dec. 20, 2019 and entitled “Valuation Method, Pricing Method, Apparatus And System For Cloud Product”, which are incorporated herein by reference in their entirety.

### TECHNICAL FIELD

The present application relates to the field of Internet technology, and in particular, to a valuation method, pricing method, apparatus and system for a cloud product.

### BACKGROUND

In related technologies, cloud products are priced by means of pricing a billing item, and a valuation is completed based on the pricing of the cloud products during a valuation process, wherein the basic principle of pricing the billing item is to define the physical accessories and resource usage, etc. in the cloud product that directly affect the product cost fee as billing items, and set pricing information of the billing items. For example, for a cloud hosting product, CPU, memory, disk, etc. of the cloud hosting product are all billing items, while the bandwidth and traffic of a network product are all billing items. During valuation, determining the value of each billing item of the to-be-valued product, and using the value and pricing information of the billing item to value the to-be-valued product.

The inventor found that, when valuing the cloud product, the related technologies only consider the own procurement cost of the billing item, which has the problem of insufficient refinement, resulting in the low price competitiveness of the cloud product.

### SUMMARY

Embodiments of the present application aim to provide a valuation method, pricing method, apparatus and system for a cloud product to improve the degree of refinement of valuation in a valuation process. The following technical solutions are provided.

In a first aspect, an embodiment of the present application provides a valuation method for a cloud product, the method including: obtaining a value of a target billing item of a to-be-valued product and values of impact factors of the target billing item, the impact factors of the target billing item correspond to the target billing item; determining a comprehensive factor corresponding to the target billing item using the values of the impact factors of the target billing item; querying pricing information of the target billing item from a preset first-type mapping relationship regarding billing items, comprehensive factors, and pricing information according to the comprehensive factor corresponding to the target billing item; and calculating a valuation fee for the to-be-valued product using the value and pricing information of the target billing item

In a second aspect, an embodiment of the present application provides a pricing method for a cloud product, the method including: obtaining a billing item of a to-be-priced product, impact factors of the billing item, and value ranges of the impact factors of the billing item, wherein the impact factors of the billing item correspond to the billing item; obtaining pricing information of the billing item given by a first pricing staff for each group of values of the impact factors of the billing item; and generating, for each group of values of the impact factors of the billing item, a comprehensive factor corresponding to the billing item using the group of values, and establishing a first-type mapping relationship regarding the billing item, the generated comprehensive factor, and the pricing information of the billing item given for the group of values, such that when valuing the cloud product, the values of the impact factors of the target billing item of the to-be-valued product is used to query the pricing information of the target billing item from the first-type mapping relationship, and the queried pricing information is used to calculate the valuation fee of the to-be-valued product.

In a third aspect, an embodiment of the present application provides a valuation apparatus for a cloud product, the apparatus including: a value acquisition module, configured for obtaining a value of a target billing item of a to-be-valued product and values of impact factors of the target billing item, the impact factors of the target billing item correspond to the target billing item; a comprehensive factor determination module, configured for determining a comprehensive factor corresponding to the target billing item using the values of the impact factors of the target billing item; an information querying module, configured for querying, according to the comprehensive factor corresponding to the target billing item, pricing information of the target billing item from a preset first-type mapping relationship regarding billing items, comprehensive factors, and pricing information; and a valuation module, configured for calculating a valuation fee for the to-be-valued product using the value and pricing information of the target billing item.

In a fourth aspect, an embodiment of the present application provides a pricing apparatus for a cloud product, the apparatus including: a first acquisition module, configured for obtaining a billing item of a to-be-priced product, impact factors of the billing item, and value ranges of the impact factors of the billing item, the impact factors of the billing item correspond to the billing item; a second acquisition module, configured for obtaining pricing information of the billing item for each group of values of the impact factors of the billing item given by a first pricing staff; and a first relationship generation module, configured for generating, for each group of values of the impact factors of the billing item, a comprehensive factor corresponding to the billing item using the group of values and establishing a first-type mapping relationship regarding the billing item, the generated comprehensive factor, and the pricing information of the billing item given for the group of values, such that when valuing the cloud product, the values of the impact factors of the target billing item of the to-be-valued product is used to query the pricing information of the target billing item from the first-type mapping relationship, and the queried pricing information is used to calculate the valuation fee of the to-be-valued product.

In a fifth aspect, an embodiment of the present application provides a valuation system for a cloud product, the system including: a pricing apparatus and a valuation apparatus. The pricing apparatus is configured for obtaining a billing item of a to-be-priced product, impact factors of the billing item, and value ranges of the impact factors of the billing item, wherein the impact factors of the billing item correspond to the billing item; obtaining pricing information of the billing item given by a first pricing staff for each group of values of the impact factors of the billing item; and generating, for each group of values of the impact factors of the billing item, a comprehensive factor corresponding to the billing item using the group of values and establishing a first-type mapping relationship regarding the billing item, the generated comprehensive factor, and the pricing information of the billing item given for the group of values. The valuation apparatus is configured for obtaining a value of a target billing item of a to-be-valued product and values of impact factors of the target billing item, the impact factors of the target billing item correspond to the target billing item; determining a comprehensive factor corresponding to the target billing item using the values of the impact factors of the target billing item; querying, according to the comprehensive factor corresponding to the target billing item, pricing information of the target billing item from a preset first-type mapping relationship regarding billing items, comprehensive factors, and pricing information; and calculating a valuation fee for the to-be-valued product using the value and pricing information of the target billing item.

In a sixth aspect, an embodiment of the present application provides an electronic device, including: a processor, a communication interface, a memory, and a communication bus. Wherein, when the processor, the communication interface, and the memory communicate with each other through the communication bus; the memory is configured for storing computer programs; and the processor is configured for executing the programs stored in the memory, the steps of the valuation method provided by the first aspect or the steps of the pricing method provided by the second aspect of the embodiment of the present application are implemented.

In a seventh aspect, an embodiment of the present application provides a computer-readable storage medium. A computer program is stored in the computer-readable storage medium, the computer program implementing the steps of the valuation method provided by the first aspect or the steps of the pricing method provided by the second aspect of the embodiment of the present application when executed by a processor.

In an eighth aspect, an embodiment of the present application provides a computer program product containing instructions, which causes a computer to execute the steps of the valuation method provided by the first aspect or the steps of the pricing method provided by the second aspect of the embodiment of the present application when running on the computer.

In a ninth aspect, the embodiment of the present application provides a computer program, which causes a computer to execute the steps of the valuation method provided by the first aspect or the steps of the pricing method provided by the second aspect of the embodiment of the present application when running on the computer.

The embodiments of the application have the following beneficial effects:

In the valuation method for the cloud product provided by the embodiment of the present application, the target billing item of the to-be-valued product and the impact factors of the target billing item are each set with values, and a first-type mapping relationship regarding billing items, comprehensive factors, and pricing information is constructed in advance. In this way, in the valuation process, using the comprehensive factor generated based on the values of the impact factors of the target billing item of the to-be-valued product as index information, the pricing information of the target billing item is determined from the first-type mapping relationship, and the valuation fee for the to-be-valued product is calculated using the value and pricing information of the target billing item. It can be seen that since the valuation scheme not only considers the billing item itself, but also applies the impact of the impact factors of the billing item on the billing item to the valuation process when valuing, the degree of refinement in the valuation process can be improved through the valuation scheme, thereby the price competitiveness of the cloud product is improved. In addition, since the impact factors corresponds to the product, it can be avoided that each billing item of the product corresponds to an impact factor, thereby greatly reducing the cost of data maintenance.

In addition, in the pricing method provided by the embodiments of the present application, for each group of values of the impact factors of the billing item of the to-be-valued product, the first pricing staff gives the pricing information of the billing item. For each group of values of the impact factors of the billing item, the group of values is used to generate the comprehensive factor corresponding to the billing item, and establish the first-type mapping relationship regarding the billing item, the generated comprehensive factor, and the pricing information of the given billing item for the group of values. In this way, when pricing the cloud product, the value of the impact factors of the target billing item of the to-be-valued product can be used to query the pricing information of the target billing item from the first-type mapping relationship, and use the queried pricing information to calculate the valuation fee of the to-be-valued product. It can be seen that since the solution not only considers the billing item itself, but also applies the impact of the impact factors of the billing item on the billing item to the pricing process to provide valuation basis for the valuation process when pricing, the degree of refinement in the valuation process can be improved through this pricing method, thereby the price competitiveness of the cloud product is improved. In addition, since the impact factors corresponds to the product, it can be avoided that each billing item of the product corresponds to the impact factor, thereby greatly reducing the cost of data maintenance.

Of course, implementing any product or method of the present application does not necessarily need to achieve all the advantages described above at the same time.

### BRIEF DESCRIPTION OF DRAWINGS

In order to more clearly describe the technical solutions of the embodiments of the present application or of the prior art, drawings that need to be used in embodiments and the prior art will be briefly described below. Obviously, the drawings provided below are for only some embodiments of the present application; those skilled in the art can also obtain other drawings based on these drawings without any creative efforts.

FIG. 1 is a flowchart of a valuation method for a cloud product provided by an embodiment of the present application;

FIG. 2 is another flowchart of a valuation method for a cloud product provided by an embodiment of the present application;

FIG. 3 is a flowchart of a pricing method for a cloud product provided by an embodiment of the present application;

FIG. 4 is a schematic structural diagram of a valuation system for a cloud product provided by an embodiment of the present application;

FIG. 5 is another schematic structural diagram of a valuation system for a cloud product provided by an embodiment of the present application;

FIG. 6 is a schematic structural diagram of a valuation apparatus for a cloud product provided by an embodiment of the present application;

FIG. 7 is a schematic structural diagram of a pricing apparatus for a cloud product provided by an embodiment of the present application;

FIG. 8 is a schematic structural diagram of an electronic device provided by an embodiment of the present application;

FIG. 9 is a schematic structural diagram of another electronic device provided by an embodiment of the present application;

FIG. 10 is another flowchart of a valuation method for a cloud product provided by an embodiment of the present application;

FIG. 11 is another flowchart of a pricing method for a cloud product provided by an embodiment of the present application.

### DETAILED DESCRIPTION

In order to make the objectives, technical solutions, and advantages of the present application clearer and more understandable, the present application will be described in more detail below with reference to the appended drawings and embodiments. Obviously, the described embodiments are only some, and not all, of the embodiments of the present application. All other embodiments obtained based on the embodiments of the present application by those skilled in the art without any creative efforts fall into the scope of protection defined by the present application.

In related technologies, cloud products are priced by means of pricing billing items, and a valuation is completed based on the pricing of the cloud products during a valuation process, wherein the basic principle of pricing the billing items is to define the physical accessories and resource usage, etc. in the product that directly affect the product cost fee as billing items, and set pricing information for the billing items. For example, for a cloud hosting product, the CPU (Central Processing Unit), memory, disk, etc. of the cloud hosting product are all billing items, while the bandwidth and traffic of a network product are all billing items. During valuation, determining the value of each billing item of the to-be-valued product, and using the value and pricing information of each billing item to value the to-be-valued product.

However, the inventor found that the actual cost of the accessories and resources represented by each billing item includes many other additional costs, such as the construction cost of the computer room where resource products are deployed and the occupation cost of the post-paid user, in addition to their own procurement cost. In addition, the procurement cost of accessories and resources with the same configuration specifications will also vary due to different supplier, types and models of accessories/resources, for example, the impact of different network link types of different network operators/the same network operator on the procurement cost of network bandwidth, and the impact of different chip suppliers on the procurement cost of CPUs of the same specification. In other words, the actual cost of the billing items is affected by certain attribute items. However, when implementing product valuation, existing cloud computing manufacturers ignore the impact of other attribute items on the billing items, so as to simplify the entire implementation logic of valuation.

In summary, when valuing cloud products, the related technologies only consider the own procurement cost of the billing items of the products, which has the problem of insufficient refinement, resulting in the low price competitiveness of cloud products.

In order to improve the degree of refinement of valuation in the valuation process, the embodiment of the present application provides a valuation method for a cloud product.

Wherein, the execution subject of the valuation method for the cloud product provided by the embodiments of the present application can be a valuation apparatus for a cloud product. The valuation apparatus can run on a server for product billing, and of course, it can also run on a client for product billing, which is also reasonable. It can be understood that the so-called cloud products in the embodiments of the present application are products formed based on cloud resources, such as cloud hostings, cloud storage products, API (Application Programming Interface) products.

Also, for the convenience of description, each attribute item that affects the billing item is named as an impact factor of the billing item, the impact factor being the factor that has an impact on the pricing. Since the impact factor is a factor that has an impact on the billing item, the impact factor corresponds to the billing item, that is, the impact factor of the billing item corresponds to the billing item. Then, for any billing item, the corresponding impact factor can be set according to the actual situation, and the impact factors corresponding to different billing items can be the same or different. In addition, both the billing item and the impact factor are configuration items, that is, items of which the user can set the value when purchasing product. For example, for the cloud hosting, CPUs, memories, and disks are all billing items. Since the CPU billing item is affected by two attribute items of the computer room and the way of payment, the computer room and the way of payment are all the impact factors of the CPU billing item. Since the disk billing item is affected by three attribute items of disk type, the computer room and the way of payment, thus the disk type, the computer room and the way of payment are all the impact factors of the disk billing item. The CPU, the memory, the disk, the computer room, the way of payment, and the type of disk are all configuration items.

In addition, it can be understood that each configuration item has a value range. The value range of the configuration item indicates the selection or value that the user can select for the configuration item when ordering options. The value can include but is not limited to enumerated values and range values, etc. For example, for the CPU, the value range can include but is not limited to 1 core, 2 cores, 4 cores, 8 cores, 16 cores, 32 cores, etc.; the value range of the memory can be 1˜1024 G; and the value range of the way of billing can include annual subscription, monthly subscription, pay-as-you-go, etc.

In order to solve related technical problems, a valuation method for a cloud product provided by the embodiment of the present application includes the following steps:

obtaining a value of a target billing item of a to-be-valued product and values of impact factors of the target billing item, the impact factors of the target billing item correspond to the target billing item;

determining a comprehensive factor corresponding to the target billing item using the values of the impact factors of the target billing item;

querying, according to the comprehensive factor corresponding to the target billing item, pricing information of the target billing item from a preset first-type mapping relationship regarding billing items, comprehensive factors, and pricing information;

calculating a valuation fee for the to-be-valued product using the value and pricing information of the target billing item.

It should be noted that the above-mentioned target billing item is a name given for the billing item of the to-be-valued product to distinguish the billing items of other products, and does not have any restrictive meaning. That is, the target billing item is one billing item of the to-be-valued product. Also, since the number of the billing items of the to-be-valued product can be one or more, the number of the target billing item can be one or more, and each target billing item corresponds to the impact factor, and it needs to determine pricing information for each target billing item.

In the valuation method for the cloud product provided by the embodiment of the present application, the target billing item of the to-be-valued product and impact factors of the target billing item are each set with values, and a first-type mapping relationship regarding billing items, comprehensive factors, and pricing information is constructed in advance. In this way, in the valuation process, using the comprehensive factor generated based on the values of the impact factors of the target billing item of the to-be-valued product as index information, the pricing information of the target billing item is determined from the first-type mapping relationship, and the valuation fee for the to-be-valued product is calculated using the value and pricing information of the target billing item. It can be seen that since the valuation scheme not only considers the billing item itself, but also applies the impact of the impact factors of the billing item on the billing item to the valuation process when valuing, the degree of refinement in the valuation process can be improved through the valuation scheme, thereby the price competitiveness of the cloud product is improved.

The following describes in detail a valuation method for the cloud product provided by the embodiment of the present application with reference to the accompanying drawings.

In order to implement the valuation method for the cloud product provided by the embodiment of the present application, a first-type mapping relationship regarding billing items, comprehensive factors, and pricing information can be established in advance. Wherein, the first-type mapping relationship can be a mapping relationship set based on the impact of the values of the impact factors on the billing item by a dedicated pricing staff.

Wherein, for the first-type mapping relationship, it includes multiple mapping entries, each mapping entry being an entry regarding billing items, comprehensive factors, and pricing information. Also, in each mapping entry of the first-type mapping relationship, the comprehensive factor is determined based on a set of values of the impact factors of the billing item in the mapping entry, and the pricing information is an price information of the billing item in the mapping entry when the set of values is selected by the impact factor of the billing item in the mapping entry. In an embodiment, mapping entries of the first-type mapping relationship can include an identifier of the billing item, a comprehensive factor, and pricing information of the billing item, but of course it is not limited to this. For example, the mapping entry of the first-type mapping can also include the name of the billing item.

Wherein, the pricing information of the billing item includes but is not limited to subdivision fields such as the selling price, unit of measurement, time unit, and pricing type, and the subdivision fields included in the pricing information can be the same as those included in the pricing information in related technologies. The following is an exemplary introduction of each segmentation field.

The unit of measurement indicates the unit of measurement which the resource usage should be converted to before the cost calculation when valuing, and the unit used to display the selling price. For example, the billing item related to the number of API (Application Programming Interface) calls can be measured in thousands or ten thousand times, indicating the selling price per thousand or ten thousand calls; the network bandwidth billing item can use M or G as the unit of measurement, indicating the selling price per M or G of bandwidth; and the storage space billing item can use G or T as the unit of measurement, indicating the selling price per G or T of storage space.

The time unit indicates the unit of time which the billing time should be converted to before the cost calculation when valuing, including but not limited to hours, days and months, etc., which respectively indicate the selling price per hour, day, and month under the unit usage.

The pricing type indicates the way of defining the selling price, including but not limited to linear unit price, one-off price, step-over-progressive unit price, step-full-progressive unit price, step-full-progressive one-off price, etc. Wherein, the linear unit price is the price of the unit usage and the unit duration, and the one-off price is the price of the unit duration, regardless of usage.

In view of the above introduction of subdivision fields, for ease of understanding, the pricing information of the CPU and the disk is exemplarily given. For example, for the CPU, the pricing information can include: 1,000 CNY, 1 core, per month, linear unit price; for the disk, the pricing information can include: 200 CNY, per month, one-off price.

Based on the above-mentioned introduction, the following describes a valuation method for a cloud product provided by the embodiment of the present application. As shown in FIG. 1, the valuation method for the cloud product provided by the embodiment of the present application can include the following steps:

S101: obtaining a value of a target billing item of a to-be-valued product and values of impact factors of the target billing item, the impact factors of the target billing item correspond to the target billing item;

S102: determining a comprehensive factor corresponding to the target billing item using the values of the impact factors of the target billing item;

S103: querying, according to the comprehensive factor corresponding to the target billing item, pricing information of the target billing item from a preset first-type mapping relationship regarding billing items, comprehensive factors, and pricing information;

S104: calculating a valuation fee for the to-be-valued product using the value and pricing information of the target billing item.

In step S101, the number of the target billing item of the to-be-valued product can be one or more. When there are multiple target billing items, the value of each target billing item of the to-be-valued product and values of the impact factors of each target billing item are obtained. In addition, since the cloud product is usually a leased product, in the valuation process, in addition to obtaining the value of the target billing item of the to-be-valued product and the values of the impact factors of the target billing item, the billing duration of the to-be-valued product can also be obtained for the subsequent valuation process.

It can be understood that there are multiple ways to determine the value of the target billing item of the to-be-valued product and the values of the impact factors of the target billing item.

Exemplarily, in an implementation, the way of determining the value of the target billing item of the to-be-valued product and the values of the impact factors of the target billing item can include steps A1-A4:

step A1: determining the target billing item of the to-be-valued product from a preset second-type mapping regarding identifiers of products and billing items of the products using an identifier of the to-be-valued product;

step A2: determining the impact factors of the target billing item from a preset third-type mapping relationship regarding billing items and impact factors;

step A3: taking a value of a configuration item that is the same as the target billing item among multiple configuration items of the to-be-valued product as the value of the target billing item;

step A4: taking values of configuration items that are the same as the impact factors of the target billing item among the multiple configuration items of the to-be-valued product as the values of the impact factors of the target billing item.

Wherein, the multiple configuration items of the to-be-valued product include the configuration item as the billing item and the configuration item as the impact factor. The value of the target billing item of the to-be-valued product and the values of the impact factors of the target billing item can be determined from the values of the multiple configuration items by combining the second-type mapping relationship and the third-type mapping relationship.

For the second-type mapping relationship, it includes multiple mapping entries, each mapping entry being an mapping entry regarding identifiers of products and billing items of products. In an implementation, the mapping entries of the second-type mapping relationship include but are not limited to the identifier of the product and of the billing item of the product, for example, can also include the name of the billing item of the product. For example, the billing items corresponding to the cloud hosting product include the CPU, the memory and the disk, then the respective mapping entries can be that the identifier of the cloud hosting product corresponds to the identifier of the CPU, the identifier of the memory and the identifier of the disk; and the billing items corresponding to the elastic IP (Internet Protocol) product include the network bandwidth, the network traffic, and the IP resources, then the respective mapping entries can be that the identifier of the elastic IP product corresponds to the identifier of the network bandwidth, the identifier of the network traffic and the identifier of the IP resources.

For the third-type mapping relationship, it includes multiple mapping entries, each mapping entry being an mapping entry regarding billing item and impact factors. In an implementation, the mapping entries of the third-type mapping relationship include but are not limited to the identifier of the billing item and the identifier of the impact factor, for example, can also include the name of the billing item and the name of the impact factor. For example, the impact factors corresponding to the CPU billing item of the cloud hosting product include the computer room and the way of payment, then the respective mapping entries are that the identifier of the CPU corresponds to the identifier of the computer room and the identifier of the way of payment; and the impact factors corresponding to the disk billing item include the type of disk, the computer room and the way of payment, then the respective mapping entries are that the identifier of the disk corresponds to the identifier of the type of disk, the identifier of the computer room and the identifier of the way of payment. For another example, the impact factors corresponding to the network bandwidth billing item of the elastic IP product include the computer room, the type of network link, the way of billing and the way of payment, then the respective mapping entries are that the identifier of the network bandwidth corresponds to the identifier of the computer room, the identifier of the type of network link, the identifier of the way of billing and the identifier of the way of payment. Wherein, the type of network link can include but not limited to BGP (Border Gateway Protocol) link, Mobile/Unicom/Telecom static link; and the way of billing can include but not limited to fixed bandwidth, daily peak bandwidth, monthly average peak bandwidth.

Exemplarily, in another implementation, when multiple configuration items of the to-be-valued product are shown in the ordering interface, the target billing items in the multiple configuration items can be set with a label value belonging to a first-type label, and the label values of the different target billing items are different, and the impact factors of the target billing item can be set with label values belonging to a second-type label and the label value of the respective target billing item. In this way, when obtaining the values of multiple configuration items, the preset label value can be used to distinguish the target billing items in the multiple configuration items and the impact factors of the target billing items, so as to determine the value of the target billing item of the to-be-valued product and the values of the impact factors of the target billing item. Wherein, before the target billing item and the impact factors of the target billing item are set with label values, the target billing item of the to-be-valued product and the impact factors of the target billing item can be identified by combining the second-type mapping relationship and the third-type mapping relationship.

In addition, it can be understood that the process of determining the value of the target billing item of the to-be-valued product and the values of the impact factors of the target billing item can be performed by a valuation apparatus. Here, the specific implementation of S101 includes steps A1-A4. Of course, the process of determining the value of the target billing item of the to-be-valued product and the values of the impact factors of the target billing item can also be performed by other apparatus communicating with the valuation apparatus. Here, the valuation apparatus can obtain the value of the target billing item of the to-be-valued product and the values of the impact factors of the target billing item from the other apparatus. In specific applications, the other apparatus can be an ordering platform for product ordering, or a special inquiry apparatus communicating with the ordering platform, but of course it is not limited to this.

In addition, the to-be-valued product can be a prepaid product or a postpaid product. Regardless of whether it is a prepaid product or a postpaid product, in order to obtain the values of multiple configuration items and the billing duration of the to-be-valued product, there is a process in which the user selects and orders for the product to be purchased. However, for the prepaid product, during the selecting and ordering process, the user has been given the values of all the configuration items of the to-be-valued product. For the postpaid product, the selecting and ordering process only gives the values of a part of the configuration items, and the values of the other part of the configuration items need to be determined by the valuation apparatus or a specific metering apparatus during the subsequent usage. For example: billing items such as peak bandwidth and traffic of the network product, billing items such as storage space and traffic of the storage product, and the billing item of the number of API calls of the API product need to be counted and analyzed regularly by the valuation apparatus or the metering apparatus after the user actually uses the resource to obtain the actual usage.

In an implementation, for the prepaid product, the way of obtaining the values of multiple configuration items and the billing duration of the to-be-valued product can include:

obtaining the values of multiple configuration items of the product ordered by the user in the product order form as the values of multiple configuration items of the to-be-valued product when the user completes the order;

obtaining the order duration of the product ordered by the user in the product order form as the billing duration of the to-be-valued product.

However, for the postpaid product, the way of obtaining the values of multiple configuration items and the billing duration of the to-be-valued product includes:

obtaining a to-be-billed instance of the resource of a postpaid product at the end of each billing cycle of the postpaid product, the to-be-billed instance of the resource including the values of multiple configuration items of the postpaid product and the actual use time of the product of the current billing cycle, the multiple configuration items of the postpaid product including the configuration items for which the user has given the values when the postpaid product is ordered and the configuration items for which the user has not given the values;

taking the values of the multiple configuration items of the postpaid product as the values of the multiple configuration items of the to-be-valued product, and taking the actual use time as the billing duration of the to-be-valued product.

Wherein, the process of obtaining the values of the multiple configuration items of the to-be-valued product and the billing duration can be performed by the valuation apparatus, and can also be performed by the apparatus other than the valuation apparatus, such as the ordering platform or the metering apparatus, of course it is not limited to this. Also, it can be understood that the values of the configuration items for which the user has given the values when the postpaid product is ordered by the user can be saved when the user selects and orders; and the values of the configuration items for which the user has not given the values can be counted by the valuation apparatus or the metering apparatus, so that the values of all the configuration items and the actual billing duration can be obtained during the subsequent valuation.

In step S102, there are multiple specific implementations of using the value of the impact factor of the target billing item to determine the comprehensive factor corresponding to the target billing item, and they correspond to the way of generating the comprehensive factor in the first-type mapping relationship.

Exemplarily, the way of determining the comprehensive factor in each mapping entry of the first-type mapping relationship can include sorting a set of values of the impact factors of the billing item according to a preset serial number of the impact factors of the billing item in the mapping entry, and forming an array of the sorted values as the comprehensive factor in the mapping entry. For example, there are two impact factors for the CPU of the cloud hosting: the computer room and the way of payment. If the value range of the computer room includes Computer Room 1 and Computer Room 2, and the value range of the way of payment includes Prepaid and Postpaid, the preset serial number of the computer room being 1, and the preset serial number of the way of payment being 2, (Computer Room 1, Prepaid), (Computer Room 2, Prepaid), (Computer Room 2, Postpaid) (Computer Room 2, Postpaid) can be used as a comprehensive factor respectively, each comprehensive factor corresponding to one pricing information.

Correspondingly, determining the comprehensive factor corresponding to the target billing item using the values of the impact factors of the target billing item can include:

sorting the values of the impact factors of the billing item according to a preset serial number of the impact factors of the billing item, and forming an array of the sorted values as the comprehensive factor corresponding to the target billing item.

Exemplarily, the way of determining the comprehensive factor in each mapping entry of the first-type mapping relationship can include performing fusion processing on the values of the impact factors of the billing item in the mapping entry according to a predetermined fusion manner to obtain the comprehensive factor in the mapping entry;

Correspondingly, determining the comprehensive factor corresponding to the target billing item using the values of the impact factors of the target billing item can include:

performing fusion processing on the values of the impact factors of the target billing item according to the predetermined fusion manner to obtain the comprehensive factor corresponding to the target billing item.

Wherein, there can be multiple ways of fusion, such as performing the data splicing processing on each value to obtain a spliced string, or calculating each value according to a predetermined signature algorithm.

For the sake of clarity of the solution, a specific implementation of performing the fusion processing on the values of the impact factors of the target billing item according to the predetermined fusion manner will be described below in conjunction with specific embodiments.

In step S103, after the comprehensive factor corresponding to the target billing item is determined, the target billing item and the comprehensive factor corresponding to the target billing item can be used as index information to search for the pricing information of the target billing item from the first-type mapping relationship.

In step S104, there are multiple implementations of calculating the valuation fee of the to-be-valued product.

Exemplarily, in an implementation, taking the value and the pricing information of the target billing item to calculate the valuation fee of the to-be-valued product can include:

calculating the billing details of the target billing item using the value and the pricing information of the target billing item and the billing duration;

determining the valuation fee of the to-be-valued product using the billing details of the target billing item.

Wherein, when there are multiple target billing items, the billing details of multiple target billing items are used to determine the valuation fees of the to-be-valued product.

For example, the target billing item of the cloud hosting includes the CPU and the disk, the value of the CPU being 2 cores, the value of the disk being 200 G, and the billing duration being 2 months. If for the CPU, the pricing information determined by the value of the impact factor of the CPU includes: 1,000 CNY, 1 core, monthly, linear unit price; and for the disk, the pricing information determined by the value of the impact factor of the disk includes: 200 CNY, monthly, one-off price, the billing details of the CPU is 1000*2*2=4000, and the billing details of the disk is 200*2.

Exemplarily, in another implementation, calculating the valuation fee of the to-be-valued product using the value and the pricing information of the target billing item can include:

calculating the billing details of the to-be-valued product using the value and the pricing information of the target billing item and the billing duration.

Wherein, when there are multiple target billing items, the billing detail of each target billing item is calculated.

It can be seen that since the valuation scheme not only considers the billing item itself, but also applies the impact of the impact factor of the billing item on the billing item to the valuation process when valuing, the degree of refinement in the valuation process can be improved through the valuation scheme, thereby the price competitiveness of the cloud product is improved.

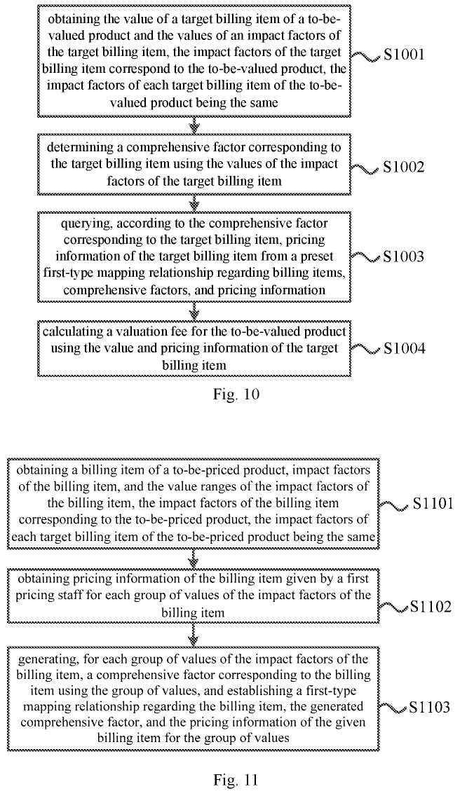

In addition, the inventor found that for an orderable cloud product, each billing item included in it usually has the same impact factor. In view of this, in order to reduce the cost of data maintenance, the impact factor can be defined in the product dimension, that is, the billing items of the same product can be set to have the same impact factor, and the billing items of different products can be set to have different impact factors. In other words, the product can be set to correspond to the impact factor, and the impact factor of the billing item of the product is the impact factor corresponding to the product. Based on this processing idea, as shown in FIG. 10, the embodiment of the present application also provides a valuation method for a cloud product.

In this embodiment, in order to implement the valuation method of the cloud product, the first-type mapping relationship regarding billing items, comprehensive factors, and pricing information can be established in advance. Wherein, the first-type mapping relationship can be a mapping relationship set by a dedicated pricing staff based on the impact of the value of the impact factor on the billing item. The detailed description of the first-type mapping relationship can refer to the corresponding content in the above-mentioned embodiments, which will not be repeated here.

In practical applications, if the billing items corresponding to a cloud product have different impact factors, for example the CPU billing item of the cloud hosting is affected by the computer room and the way of payment, and the pricing of the disk billing item of the cloud hosting is affected by the type of disk in addition to the computer room and the way of payment, the cloud product can be defined as a combination of multiple sub-products by means of the product definition split, such that the impact factors of all billing items corresponding to each sub-product is the same. At this time, each sub-product can be used as a to-be-valued product. For example, the cloud computing manufacturer can define a true cloud hosting product as two sub-products: one is a cloud hosting consisting of two billing items of the CPU and the memory with the same impact factor, and the other is a hard disk consisting of a single billing item which is the storage space. In this way, when the user orders the true cloud hosting product, it is actually completed by automatically ordering the two sub-products of the cloud hosting and the hard disk at the same time through the system. The impact factors of the billing items of each sub-product are the same.

As shown in FIG. 10, a calculation method of a cloud product provided by the embodiment of the present application can include the following steps:

S1001: obtaining the value of a target billing item of a to-be-valued product and the values of an impact factors of the target billing item, the impact factors of the target billing item correspond to the to-be-valued product, the impact factors of each target billing item of the to-be-valued product being the same;

S1002: determining a comprehensive factor corresponding to the target billing item using the values of the impact factors of the target billing item;

S1003: querying, according to the comprehensive factor corresponding to the target billing item, pricing information of the target billing item from a preset first-type mapping relationship regarding billing items, comprehensive factors, and pricing information;

S1004: calculating a valuation fee for the to-be-valued product using the value and pricing information of the target billing item.

In this embodiment, step S1001 is similar to S101 in the embodiment shown in FIG. 1, except that the impact factors of the target billing item not only corresponds to the target billing item, but also corresponds to the to-be-valued product. The impact factors of each target billing item of the to-be-valued product are the same.

Based on the above difference, the way of determining the value of the target billing item of the to-be-valued product and the values of the impact factors of the target billing item is different from the determination process in the embodiment shown in FIG. 1.

Exemplarily, in an implementation, the way of determining the value of the target billing item of the to-be-valued product and the value of the impact factor of the target billing item can include steps D1-D4:

step D1: determining a target billing item of the to-be-valued product from a preset second-type mapping relationship regarding the identifier of the product and the billing item of the product using an identifier of a to-be-valued product;

step D2: determining an impact factor corresponding to the identifier of the to-be-valued product as the impact factor of the target billing item from a preset fifth-type mapping relationship regarding identifiers of products and impact factors;

step D3: taking a value of a configuration item that is the same as the target billing item among the multiple configuration items of the to-be-valued product as the value of the target billing item;

step D4: taking a value of a configuration item that is the same as the impact factor of the target billing item among the multiple configuration items of the to-be-valued product as the value of the impact factor of the target billing item.

Wherein, the multiple configuration items of the to-be-valued product include the configuration item as the billing item and the configuration item as the impact factor. The value of the target billing item of the to-be-valued product and the value of the impact factor of the target billing item can be determined from the values of the multiple configuration items by combining the second-type mapping relationship and the fifth-type mapping relationship. Wherein, in this embodiment, the second-type mapping relationship is the same as the second-type mapping relationship in the embodiment shown in FIG. 1. The related description of the second-type mapping relationship can refer to the corresponding content in the above-mentioned embodiment shown in FIG. 1, which will not be repeated here.

In this embodiment, for the fifth-type mapping relationship, it includes multiple mapping entries, each mapping entry being an mapping entry regarding the identifier and the impact factor of the product. In an implementation, the mapping entries of the fifth-type mapping relationship include but are not limited to the identifier of the product and of the impact factor, for example, can also include the name of the product and of the impact factor. For example, the impact factors of the two billing items, the CPU and the memory, of the cloud hosting product are the computer room and the way of payment. The respective mapping entries can be that the identifier of the cloud hosting corresponds to the identifier of the computer room and the identifier of the way of payment.

Exemplarily, in another implementation, when multiple configuration items of the to-be-valued product are shown in the ordering interface, the target billing items in the multiple configuration items can be set with a first-type label, and the impact factors in the multiple configuration items can be set with a second-type label. In this way, when obtaining the values of multiple configuration items, the target billing items in the multiple configuration items and the impact factors of the target billing items can be distinguished by using the preset labels, so that the value of the target billing item of the to-be-valued product and the value of the impact factor of the target billing item can be determined. Wherein, before setting labels for the target billing item and the impact factor of the target billing item, the target billing item of the to-be-valued product and the impact factor of the target billing item can be identified by combining the second-type mapping relationship and the fifth-type mapping relationship.

In this embodiment, steps S1002-S1004 are the same as S102-S104 in the embodiment shown in FIG. 1, which will not be repeated here.

In addition, since in some scenarios, the cloud product that the user needs to order in the true sense can include at least two to-be-valued products, in order to determine the valuation fee of the cloud product, after calculating the valuation fees of the to-be-valued products, the method can further include:

calculating the valuation fee of the cloud product based on the valuation fees of the to-be-valued products.

Specifically, after obtaining the valuation fee of each to-be-valued product, the sum of the valuation fees each to-be-valued product can be used as the valuation fee of the cloud product.

It can be seen that since the valuation scheme not only considers the billing item itself, but also applies the impact of the impact factor of the billing item on the billing item to the valuation process when valuing, the degree of refinement in the valuation process can be improved through the valuation scheme, thereby the price competitiveness of the cloud product is improved. In addition, since the impact factor corresponds to the product, it can be avoided that each billing item of the product corresponds to an impact factor, thereby greatly reducing the cost of data maintenance.

Based on the embodiments shown in FIG. 1 and FIG. 10, the following describes a valuation method for a cloud product provided by the embodiments of the present application in conjunction with specific embodiments.

In order to realize the valuation of the prepaid cloud product, the first-type mapping relationship regarding billing items, comprehensive factors, and pricing information is established in advance.

In order to ensure that the length of the comprehensive factor corresponding to each billing item is uniform, thereby realizing efficient management, the way of determining the comprehensive factor in each mapping entry of the first-type mapping relationship can include: sorting the values of the impact factors of the billing item in the mapping entry according to a predetermined sorting manner, and performing splicing processing on the sorted values to obtain the spliced data; and performing signature calculation on the spliced data according to a predetermined signature algorithm to obtain the signature data as the comprehensive factor in the mapping entry.

Wherein, the signature algorithm can include, but is not limited to, MD5 (message-digest algorithm 5), SHA-1 (Secure Hash Algorithm 1), SHA-2 (Secure Hash Algorithm 2) and other algorithms. It should be noted that since the value range of some impact factors is selected, in order to facilitate calculation, each selected value can be quantified into a string, so that data splicing can be realized. For example, the value range of the computer room includes Computer Room 1 and Computer Room 2. Computer Room 1 can be quantified as 0001, and Computer Room 2 can be quantified as 0002.

In addition, serial numbers can be set for impact factors, so that sorting can be performed according to the serial numbers. At this time, the predetermined sorting manner can be a way of sorting based on the serial numbers.

The other related description of the first-type mapping relationship refers to the related description of the above-mentioned embodiment, which will not be repeated here.

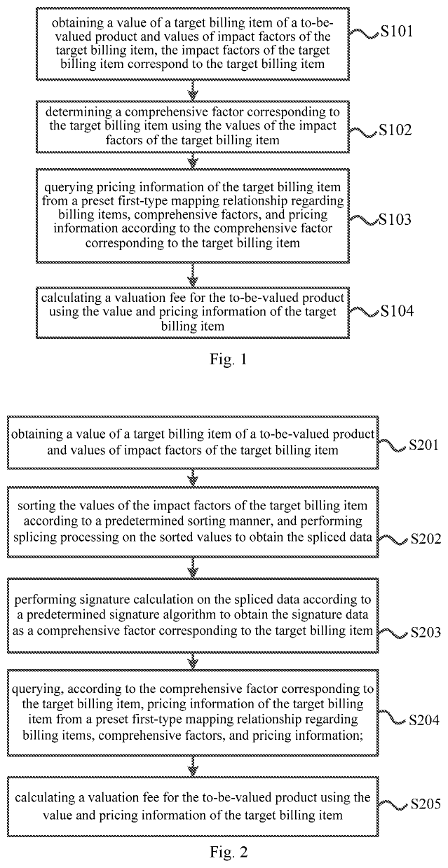

As shown in FIG. 2, a valuation method for a cloud product provided by the embodiments of the present application can include the following steps:

S201: obtaining a value of a target billing item of a to-be-valued product and values of impact factors of the target billing item;

S202: sorting the values of the impact factors of the target billing item according to a predetermined sorting manner, and performing splicing processing on the sorted values to obtain the spliced data;

S203: performing signature calculation on the spliced data according to a predetermined signature algorithm to obtain the signature data as a comprehensive factor corresponding to the target billing item;

S204: querying, according to the comprehensive factor corresponding to the target billing item, pricing information of the target billing item from a preset first-type mapping relationship regarding billing items, comprehensive factors, and pricing information;

S205: calculating a valuation fee for the to-be-valued product using the value and pricing information of the target billing item.

Wherein, if the pre-established third-type mapping relationship is a mapping relationship regarding billing items and impact factors, step S201 in this embodiment is the same as step S101 in the above-mentioned embodiment, which will not be repeated here; and if the pre-established fifth-type mapping relationship is a mapping relationship regarding products and impact factors, step S201 in this embodiment is the same as step S1001 in the above-mentioned embodiment, which will not be repeated here. Steps S204-S205 in this embodiment are the same as steps S103-S104 in the above-mentioned embodiment, which will not be repeated here.

Based on the way of determining the comprehensive factor of each mapping entry of the first-type mapping relationship, it can be known that the way of determining the impact factors of the target billing item can include sorting the values of the impact factors of the target billing item based on the serial numbers of the impact factors of the target billing item, and performing splicing processing on the sorted values to obtain the spliced data; and performing signature calculation on the spliced data according to a predetermined signature algorithm to obtain the signature data as the comprehensive factor corresponding to the target billing item. Wherein, the signature algorithm for generating the comprehensive factor corresponding to the target billing item is the same as the above-mentioned signature algorithm used for generating the comprehensive factor in the first-type mapping. Exemplarily, the signature algorithm can include, but is not limited to, MD5 (message-digest algorithm 5), SHA-1 (Secure Hash Algorithm 1), SHA-2 (Secure Hash Algorithm 2) and other algorithms. The length of the signature data can be set according to the actual condition, which is not limited in the embodiment of the present application.

Since the valuation method for a cloud product provided by the embodiments of the present application not only considers the billing item itself, but also applies the impact of the impact factor of the billing item on the billing item to the valuation process when valuing, the degree of refinement in the valuation process can be improved through the valuation scheme, thereby the price competitiveness of the cloud product is improved. At the same time, the way of determining comprehensive factors can make the length of the comprehensive factors uniform, which facilitates the efficient management of data. In addition, if the pre-established fifth-type mapping relationship is a mapping relationship regarding products and impact factors, since the impact factor corresponds to the product, it can be avoided that each billing item of the product corresponds to an impact factor, thereby greatly reducing the cost of data maintenance.

Based on the embodiment shown in FIG. 1, the following takes a prepaid cloud product as an example to introduce a valuation method for a cloud product provided by the embodiment of the present application.

In order to realize the valuation of the prepaid cloud product, multiple types of mapping relationship are established in advance. The multiple types of mapping relationship can be stored in different databases, or the same database. The multiple mapping relationships at least include:

a first-type mapping relationship regarding billing items, comprehensive factors, and pricing information;

a second-type mapping relationship regarding identifiers of the products and billing items of the products;

a third-type mapping relationship regarding billing items and impact factors.

The detailed introduction content of the above-mentioned mappings refers to the related description of the above-mentioned embodiments, which will not be repeated here.

A valuation method for a cloud product provided by the embodiment of the present application can include steps B1-B9:

step B1: obtaining values of multiple configuration items of the product ordered by the user in the product order form as the values of multiple configuration items of a to-be-valued product when the user completes the order;

step B2: obtaining an order duration of the product ordered by the user in the product order form as a billing duration of the to-be-valued product;

step B3: determining a target billing item of the to-be-valued product from a preset second-type mapping relationship regarding identifiers of products and billing items of the products using an identifier of the to-be-valued product;

step B4: determining impact factors of the target billing item from a preset third-type mapping relationship regarding billing items and impact factors;

step B5: taking a value of a configuration item that is the same as the target billing item among the multiple configuration items of the to-be-valued product as the value of the target billing item;

step B6: taking values of the configuration item that are the same as the impact factors of the target billing item among the multiple configuration items of the to-be-valued product as the values of the impact factors of the target billing item;

step B7: determining a comprehensive factor corresponding to the target billing item using the values of the impact factors of the target billing item;

step B8: querying, according to the comprehensive factor corresponding to the target billing item, pricing information of the target billing item from a preset first-type mapping relationship regarding billing items, comprehensive factors, and pricing information;

step B9: calculating a valuation fee for the to-be-valued product using the value and pricing information of the target billing item and the billing duration.

When the user needs to select the product, he can enter an interactive interface used to place an order for a product. The interactive interface contains the value range of multiple configuration items of the prepaid product. Except for the billing item in the related technologies, the multiple configuration items also includes the impact factors of each billing item. In this way, the user can select the value of the billing item and the impact factors through the interactive interface, and give the order duration. Correspondingly, when the user completes the order, the server can obtain the values of multiple configuration items of the product ordered by the user in the product order form as the values of multiple configuration items of the to-be-valued product.

It can be understood that the interactive interface can be output by a web client or APP. The server corresponding to the web client or APP can be a server running with the valuation apparatus, or it can be the other server communicating with the server running with the valuation apparatus, which are all reasonable.

In addition, since prepayment is a value of the way of payment, the prepaid product can be a product formed when the user selects the prepayment among the ways of payment.

It can be seen that since the solution provided by this embodiment not only considers the billing item itself, but also applies the impact factor to the valuation process when valuing the prepaid product, the degree of refinement in the valuation process can be improved through this solution, thereby the price competitiveness of the cloud product is improved.

Based on the embodiment shown in FIG. 1, the following takes a postpaid cloud product as an example to introduce a valuation method for a cloud product provided by the embodiment of the present application.

In order to realize the valuation of the postpaid cloud product, multiple types of mapping relationship are established in advance. The multiple types of mapping relationship can be stored in different databases, or the same database. The multiple mapping relationships at least include:

a first-type mapping relationship regarding billing items, comprehensive factors, and pricing information;

a second-type mapping relationship regarding identifiers of the products and billing items of the products;

a third-type mapping relationship regarding billing items and impact factors.

The detailed introduction content of the above-mentioned mapping relationships refers to the related description of the above-mentioned embodiments, which will not be repeated here.

A valuation method for a cloud product provided by the embodiment of the present application can include steps C1-C9:

step C1: obtaining a to-be-billed instance of the resource of the postpaid product at the end of each billing cycle of the postpaid product, the to-be-billed instance of the resource including the values of multiple configuration items of the postpaid product and the actual use time of the product of the current billing cycle, the multiple configuration items of the postpaid product including the configuration items for which the user has given the values when the postpaid product is ordered and the configuration items for which the user has not given the values;

wherein, the billing cycle can be one week, one month, half a year, etc., which can be specifically set according to the actual condition.

step C2: taking the values of the multiple configuration items of the postpaid product as the values of the multiple configuration items of the to-be-valued product, and taking the actual use time as the billing duration of the to-be-valued product;

step C3: determining a target billing item of the to-be-valued product from a preset second-type mapping relationship regarding identifiers of the products and billing items of the products using the identifier of the to-be-valued product;

step C4: determining impact factors of the target billing item from a preset third-type mapping relationship regarding billing items and impact factors;

step C5: taking a value of a configuration item that is the same as the target billing item among the multiple configuration items of the to-be-valued product as the value of the target billing item;

step C6: taking values of the configuration items that is the same as the impact factors of the target billing item among the multiple configuration items of the to-be-valued product as the values of the impact factors of the target billing item;

step C7: determining a comprehensive factor corresponding to the target billing item using the values of the impact factors of the target billing item;

step C8: querying, according to the comprehensive factor corresponding to the target billing item, pricing information of the target billing item from a preset first-type mapping relationship regarding billing items, comprehensive factors, and pricing information;

step C9: calculating a valuation fee for the to-be-valued product using the value and pricing information of the target billing item and the billing duration.

For the postpaid product, the selecting and ordering process only gives the values of a part of the configuration items, and the values of the other part of the configuration items need to be determined by the valuation apparatus or a specific metering apparatus during the subsequent usage.

In an implementation, for the postpaid product, when the user needs to select the product, he can enter an interactive interface used to select and place an order for the product. The interactive interface at least contains the part of the configuration items of the postpaid product. Except for the billing item in the related technologies, the part of the configuration items also include the impact factors of the billing items. In this way, the user can select the value of the part of the billing item and the impact factors through the interactive interface. It can be understood that the values of the configuration items for which the user has given the values when the postpaid product is ordered by the user can be saved when the user selects and orders; and the values of the configuration items for which the user has not given the values can be counted by the valuation apparatus or the dedicated metering apparatus, so that the values of all the configuration items and the actual billing duration can be obtained during the subsequent valuation.

It can be understood that the interactive interface can be output by a web client or APP. The server corresponding to the web client or APP can be a server running with the valuation apparatus, or it can be the other server communicating with the server running with the valuation apparatus, which are all reasonable.

It can be understood that since the post-payment is a value of the way of payment, the postpaid product can be a product formed when the user selects the post-payment among the ways of payment.

It can be seen that since the solution provided by this embodiment not only considers the billing item itself, but also applies the impact of the impact factor on the billing item to the valuation process when valuing the postpaid product, the degree of refinement in the valuation process can be improved through this solution, thereby the price competitiveness of the cloud product is improved.

Based on the embodiment shown in FIG. 10, the following takes a prepaid cloud product as an example to introduce a valuation method for a cloud product provided by the embodiment of the present application.

In order to realize the valuation of the prepaid cloud product, multiple types of mapping relationship are established in advance. The multiple types of mapping can be stored in different databases, or the same database. The multiple mapping relationships at least include:

a first-type mapping relationship regarding billing items, comprehensive factors, and pricing information;

a second-type mapping relationship regarding identifiers of the products and billing items of the products;

a fifth-type mapping relationship regarding identifiers of products and impact factors.

The detailed introduction content of the above-mentioned mapping relationships refers to the related description of the above-mentioned embodiments, which will not be repeated here.

A valuation method for a cloud product provided by the embodiment of the present application can include steps E1-E9:

step E1: obtaining values of multiple configuration items of a product ordered by the user in the product order form as the values of multiple configuration items of a to-be-valued product when the user completes the order;

step E2: obtaining an order duration of the product ordered by the user in the product order form as the billing duration of the to-be-valued product;

step E3: determining a target billing item of the to-be-valued product from a preset second-type mapping regarding identifiers of the products and billing items of the products using the identifier of the to-be-valued product;

step E4: determining impact factors corresponding to the identifier of the to-be-valued product as the impact factors of the target billing item from a preset fifth-type mapping relationship regarding identifiers of products and impact factors.

step E5: taking a value of a configuration item that is the same as the target billing item among the multiple configuration items of the to-be-valued product as the value of the target billing item;

step E6: taking values of the configuration items that are the same as the impact factors of the target billing item among the multiple configuration items of the to-be-valued product as the values of the impact factors of the target billing item;

step E7: determining a comprehensive factor corresponding to the target billing item using the values of the impact factors of the target billing item;

step E8: querying, according to the comprehensive factor corresponding to the target billing item, pricing information of the target billing item from a preset first-type mapping relationship regarding billing items, comprehensive factors, and pricing information;

step E9: calculating a valuation fee for the to-be-valued product using the value and pricing information of the target billing item and the billing duration.

When the user needs to select the product, he can enter an interactive interface used to select and place an order for the product. The interactive interface contains the value range of multiple configuration items of the prepaid product. Except for the billing item of the product in the related technologies, the multiple configuration items also includes the impact factors of each billing item. In this way, the user can select the value of the billing item and the impact factor through the interactive interface, and give the order duration. Correspondingly, when the user completes the order, the server can obtain the values of multiple configuration items of the product ordered by the user in the product order form as the values of multiple configuration items of the to-be-valued product.

It can be understood that the interactive interface can be output by a web client or APP. The server corresponding to the web client or APP can be a server running with the valuation apparatus, or it can be the other server communicating with the server running with the valuation apparatus, which are all reasonable.

In addition, since prepayment is a value of the way of payment, the prepaid product can be a product formed when the user selects the prepayment among the ways of payment.

It can be seen that since the solution provided by this embodiment not only considers the billing item itself, but also applies the impact factor to the valuation process when valuing the prepaid product, the degree of refinement in the valuation process can be improved through this solution, thereby the price competitiveness of the cloud product is improved. In addition, since the impact factor corresponds to the product, it can be avoided that each billing item of the product corresponds to an impact factor, thereby greatly reducing the cost of data maintenance.

Based on the embodiment shown in FIG. 10, the following takes a postpaid cloud product as an example to introduce a valuation method for a cloud product provided by the embodiment of the present application.

In order to realize the valuation of the postpaid cloud product, multiple types of mapping relationship are established in advance. The multiple types of mapping relationship can be stored in different databases, or the same database. The multiple mapping relationships at least include:

a first-type mapping relationship regarding billing items, comprehensive factors, and pricing information;

a second-type mapping relationship regarding identifiers of the products and billing items of the products;

a fifth-type mapping relationship regarding identifiers of products and impact factors.

The detailed introduction content of the above-mentioned mapping relationships refers to the related description of the above-mentioned embodiments, which will not be repeated here.

A valuation method for a cloud product provided by the embodiment of the present application can include steps F1-F9:

step F1: obtaining a to-be-billed instance of the resource of the postpaid product at the end of each billing cycle of the postpaid product, the to-be-billed instance of the resource including the values of multiple configuration items of the postpaid product and the actual use time of the product of the current billing cycle, the multiple configuration items of the postpaid product including the configuration items for which the user has given the values when the postpaid product is ordered and the configuration items for which the user has not given the values;

wherein, the billing cycle can be one week, one month, half a year, etc., which can be specifically set according to the actual condition.

step F2: taking values of the multiple configuration items of the postpaid product as the values of the multiple configuration items of the to-be-valued product, and taking the actual use time as the billing duration of the to-be-valued product;

step F3: determining a target billing item of the to-be-valued product from a preset second-type mapping relationship regarding identifiers of the products and billing items of the products using an identifier of the to-be-valued product;

step F4: determining impact factors corresponding to the identifier of the to-be-valued product as the impact factors of the target billing item from a preset fifth-type mapping relationship regarding identifiers of products and impact factors;

step F5: taking a value of a configuration item that is the same as the target billing item among the multiple configuration items of the to-be-valued product as the value of the target billing item;

step F6: using values of the configuration items that are the same as the impact factors of the target billing item among the multiple configuration items of the to-be-valued product as the values of the impact factors of the target billing item;

step F7: taking the values of the impact factors of the target billing item to determine a comprehensive factor corresponding to the target billing item;

step F8: querying, according to the comprehensive factor corresponding to the target billing item, pricing information of the target billing item from a preset first-type mapping relationship regarding billing items, comprehensive factors, and pricing information;

step F9: calculating a valuation fee for the to-be-valued product using the value and pricing information of the target billing item and the billing duration.

For the postpaid product, the selecting and ordering process only gives the values of a part of the configuration items, and the values of the other part of the configuration items need to be determined by the valuation apparatus or a dedicated metering apparatus during the subsequent usage.

In an implementation, for the postpaid product, when the user needs to select the product, he can enter the interactive interface used to select and place an order for the product. The interactive interface at least contains the part of the configuration items of the postpaid product. Except for the billing item of the product in the related technologies, the part of the configuration items also include the impact factors of the billing items. In this way, the user can select the value of the part of the billing item and the impact factor through the interactive interface. It can be understood that the values of the configuration items for which the user has given the values when the postpaid product is ordered by the user can be saved when the user selects and orders; and the values of the configuration items for which the user has not given the values can be counted by the valuation apparatus or the dedicated metering apparatus, so that the values of all the configuration items and the actual billing duration can be obtained during the subsequent valuation.

It can be understood that the interactive interface can be output by a web client or APP. The server corresponding to the web client or APP can be a server running with the valuation apparatus, or it can be the other server communicating with the server running with the valuation apparatus, which are all reasonable.

It can be understood that since the post-payment is a value of the way of payment, the postpaid product can be a product formed when the user selects the post-payment among the ways of payment.

It can be seen that since the solution provided by this embodiment not only considers the billing item itself, but also applies the impact of the impact factor on the billing item to the valuation process when valuing the postpaid product, the degree of refinement in the valuation process can be improved through this solution, thereby the price competitiveness of the cloud product is improved. In addition, since the impact factor corresponds to the product, it can be avoided that each billing item of the product corresponds to the impact factor, thereby greatly reducing the cost of data maintenance.

In addition, the embodiment of the present application also provides a pricing method for a cloud product. The pricing method not only considers the billing item itself, but also applies the impact of the impact factor of the billing item on the billing item to the pricing process to provide valuation basis for the valuation process. Therefore, the degree of refinement in the valuation process can be improved through this pricing method, thereby the price competitiveness of the cloud product is improved.

Wherein, the execution subject of the pricing method for the cloud product provided by the embodiments of the present application can be a pricing apparatus for the cloud product. The pricing apparatus can run on a server for product pricing. Also, the pricing process related in this embodiment is the process of generating the first-type mapping relationship in the above-mentioned embodiment. The first-type mapping relationship generated through the pricing process can provide valuation basis for the subsequent valuation process based on impact factors.

A pricing method for a cloud product provided by the embodiment of the present application can include the following steps:

obtaining a billing item of a to-be-priced product, impact factors of the billing item, and value ranges of the impact factors of the billing item, the impact factors of the billing item correspond to the billing item;

obtaining pricing information of the billing item given by a first pricing staff for each group of values of the impact factors of the billing item;

generating, for each group of values of the impact factors of the billing item, a comprehensive factor corresponding to the billing item using the group of values, and establishing a first-type mapping relationship regarding the billing item, the generated comprehensive factor, and the pricing information of the given billing item for the group of values.

It can be seen that since the solution not only considers the billing item itself, but also applies the impact of the impact factors of the billing item on the billing item to the pricing process to provide valuation basis for the valuation process, the degree of refinement in the valuation process can be improved through this pricing method, thereby the price competitiveness of the cloud product is improved.

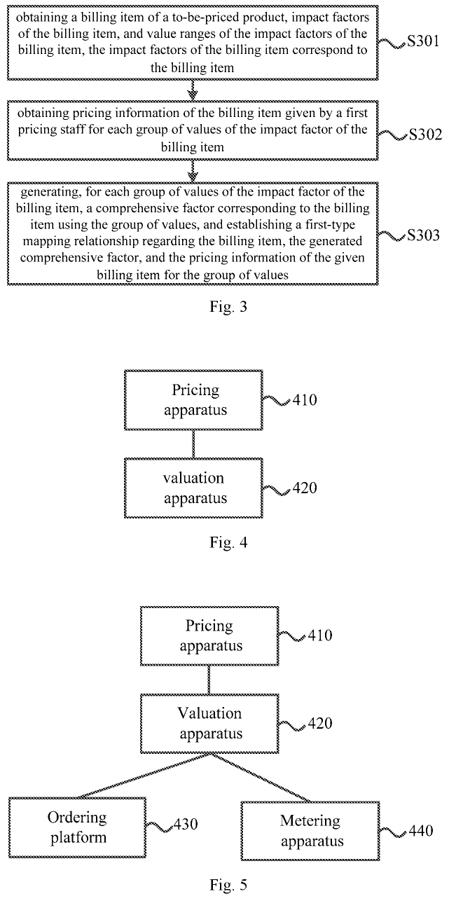

Based on the content of the embodiment shown in FIG. 1, as shown in FIG. 3, a pricing method for a cloud product provided by the embodiment of the present application can include the following steps:

S301: obtaining a billing item of a to-be-priced product, impact factors of the billing item, and value ranges of the impact factors of the billing item, the impact factors of the billing item correspond to the billing item;

S302: obtaining pricing information of the billing item given by a first pricing staff for each group of values of the impact factor of the billing item;

S303: generating, for each group of values of the impact factor of the billing item, a comprehensive factor corresponding to the billing item using the group of values, and establishing a first-type mapping relationship regarding the billing item, the generated comprehensive factor, and the pricing information of the given billing item for the group of values.

By generating the first-type mapping relationship, when pricing the cloud product, the values of the impact factors of the target billing item of the to-be-valued product is used to query the pricing information of the target billing item from the first-type mapping relationship, and the queried pricing information is used to calculate a valuation fee of the to-be-valued product.

In step S301, there are one or more billing items of the to-be-priced product. Each billing item has impact factors, and each billing item can has one or more impact factors. In addition, there are multiple specific implementation of obtaining the billing item of the to-be-priced product, the impact factors of the billing item, and the value ranges of the impact factors of the billing item.

Exemplarily, in an implementation, multiple types of mapping relationship are established in advance. The multiple types of mapping relationship can be stored in different databases, or the same database. Specifically, the multiple types of mapping relationship is as follows:

a second-type mapping relationship regarding identifiers of the products and billing items of the products;

a third-type mapping relationship regarding billing items and impact factors;

a fourth-type mapping relationship regarding configuration items and value ranges.

Wherein, the related description regarding the second-type mapping relationship and the third-type mapping relationship refers to the description of the above-mentioned embodiments, which will not be repeated here.

For the fourth-type mapping relationship, it includes multiple mapping entries, each mapping entry being an entry regarding the configuration item and the value range. Wherein, the value range of the configuration item indicates the selection or value that the user can select for the configuration item when ordering options. The value can include but is not limited to enumerated values and range values, etc. In an implementation, the mapping entry of the fourth-type mapping relationship includes, but is not limited to, the identifier of the configuration item and the value range of the configuration item, and can also include the name of the configuration item, for example. Exemplarily, for the CPU, the value range can include but is not limited to 1 core, 2 cores, 4 cores, 8 cores, 16 cores, 32 cores, etc. Then corresponding mapping entries can be that the identifier of the CPU corresponds to 1 core, 2 cores, 4 cores, 8 cores, 16 cores, 32 cores, etc. The value range of the memory can be 1˜1024 G Then corresponding mapping entries can be that the identifier of the memory corresponds to 1˜1024 G The value ranges of the way of billing can include annual subscription, monthly subscription, pay-as-you-go, etc. Then corresponding mapping entries can be that the identifier of the way of billing corresponds to annual subscription, monthly subscription, pay-as-you-go, etc.

Based on the multiple types of mapping relationship, obtaining the billing item of the to-be-priced product, the impact factors of the billing item, and the value ranges of the impact factors of the billing item can include:

querying the billing item of the to-be-priced product from the preset second-type mapping relationship regarding identifiers of the products and billing items of the products using the identifier of the to-be-priced product;

querying the impact factors of the billing item of the to-be-priced product from the preset third-type mapping relationship regarding billing items and impact factors;

querying the value ranges of the impact factors of the billing item from the preset fourth-type mapping relationship regarding configuration items and value ranges.

In this implementation, the first pricing staff can specify an identifier of the to-be-priced product to a pricing apparatus, thus the pricing apparatus can use the identifier of the to-be-priced product as a query basis to query the second-type mapping relationship, the third-type mapping relationship and the fourth-type mapping relationship to obtain the billing item of the to-be-priced product, the impact factors of the billing item, and the value ranges of the impact factors of the billing item.

Exemplarily, in another implementation, the specific implementation of obtaining the billing item of the to-be-priced product, the impact factors of the billing item, and the value ranges of the impact factors of the billing item can include: obtaining the billing item of the to-be-priced product given by the first pricing staff; determining the impact factors of the billing item using the third-type mapping relationship; and determining the value ranges of the impact factors of the billing item using the fourth-type mapping relationship.

The above-mentioned specific implementation of obtaining the billing item of the to-be-priced product, the impact factors of the billing item, and the value ranges of the impact factors of the billing item is merely as an example, and should not constitute a limitation to the embodiments of the present application.

In step S302, the first pricing staff can give the pricing information of the billing item for each group of values of the impact factors of the billing item through a pricing management interface. Based on this processing idea, after obtaining the billing item of the to-be-priced product, the impact factors of the billing item, and the value ranges of the impact factors of the billing item, and before obtaining the pricing information of the billing item for each group of values of the impact factors of the billing item given by the first pricing staff, the method further includes: displaying the pricing management interface, the pricing management interface including the billing item of the to-be-priced product, the impact factors of the billing item, and the value ranges of the impact factors of the billing item.

Obtaining the pricing information of the billing item for each group of values of the impact factors of the billing item given by the first pricing staff includes: obtaining the pricing information of the billing item for each group of values of the impact factors of the billing item given by the first pricing staff through the pricing management interface.

It can be understood that the first pricing staff can give the pricing information of the billing item for each group of values of the impact factors of the billing item according to actual pricing needs. In this way, the pricing information of the billing item for each group of values of the impact factors of the billing item given by the first pricing staff can be obtained. For example, assuming that the billing item is the CPU, there are two impact factors of the billing item: the computer room and the way of payment. If the value range of the computer room includes Computer Room 1 and Computer Room 2, and the value range of the way of payment includes Prepaid and Postpaid, the pricing information for the CPU given by the first pricing staff as shown in Table 1:

TABLE 1

| values of the impact factors | pricing information |
|---|---|
| Computer Room 1, Prepaid | Pricing 1 |
| Computer Room 2, Prepaid | Pricing 2 |
| Computer Room 1, Postpaid | Pricing 3 |
| Computer Room 2, Postpaid | Pricing 4 |

In step S303, there are multiple implementations of using the group of values to generate the comprehensive factor corresponding to the billing item for each group of values of the impact factors of the billing item.

Exemplarily, in an implementation, generating the comprehensive factor corresponding to the billing item for each group of values of the impact factors of the billing item using the group of values includes: performing fusion processing on the group of value according to a predetermined fusion manner to obtain the comprehensive factor corresponding to the billing item for each group of values of the impact factors of the billing item. Wherein, there can be multiple ways of fusion, such as performing the data splicing processing on each value to obtain a spliced string, or calculating each value according to a predetermined signature algorithm.

In order to ensure that the length of the comprehensive factors corresponding to each billing items is uniform, thereby realizing efficient management, optionally, performing the fusion processing on the group of value according to the predetermined fusion manner to obtain the comprehensive factor corresponding to the billing item for each group of values of the impact factors of the billing item can include:

for each group of values of the impact factors of the billing item, sorting the values of the impact factors of the billing item according to a predetermined sorting manner, and performing the splicing processing on the sorted values to obtain the spliced data; and performing signature calculation on the spliced data according to a predetermined signature algorithm to obtain the signature data as the comprehensive factor corresponding to the billing item.

Wherein, the signature algorithm can include, but is not limited to, MD5 (message-digest algorithm 5), SHA-1 (Secure Hash Algorithm 1), SHA-2 (Secure Hash Algorithm 2) and other algorithms. It should be noted that since the value ranges of some impact factors is selected, in order to facilitate calculation, each selected value can be quantified into a string, so that data splicing can be realized. For example, the value range of the computer room includes Computer Room 1 and Computer Room 2. Computer Room 1 can be quantified as 0001, and Computer Room 2 can be quantified as 0002.

In addition, serial numbers can be set for impact factors, so that sorting can be performed according to the serial numbers. At this time, the predetermined sorting manner can be a way of sorting based on the serial numbers. It can be understood that the above-mentioned implementation of using the group of values to generate the comprehensive factor corresponding to the billing item for each group of values of the impact factors of the billing item is merely as an example, and should not constitute a limitation to the embodiments of the present application. For example, the group of values can also be used to form an array and the array being used as the comprehensive factor corresponding to the billing item.

In addition, for the solution in which the second-type mapping relationship, the third-type mapping relationship, and the fourth-type mapping relationship exist, before obtaining the billing item of the to-be-priced product, the impact factors of the billing item, and the value ranges of the impact factors of the billing item, the pricing method for the cloud product can also include:

obtaining an identifier of the product given by a second pricing staff and a specified billing item for the given product, and generating the second-type mapping regarding the given identifier of the product and the specified billing item;

obtaining a billing item given by the second pricing staff and a specified impact factor for the given billing item, and generating the third-type mapping relationship regarding the given billing item and the specified impact factor;

obtaining a configuration item given by the second pricing staff and the specified value range for the given configuration item, and generating the fourth-type mapping relationship regarding the given configuration item and the specified value range, the given configuration item including the specified impact factor.

For the second-type mapping relationship, the third-type mapping relationship and the fourth-type mapping relationship, the second pricing staff can specify the identifier of the product, the billing item of the product and the impact factors of the billing item of the product by the specified configuration interface, so that the pricing apparatus can obtain various information to generate various mapping relationships.

In the pricing method provided by the embodiments of the present application, for each group of values of the impact factors of the billing item of the to-be-valued product, the first pricing staff specifies the pricing information of the billing item. For each group of values of the impact factors of the billing item, the group of values is used to generate the comprehensive factor corresponding to the billing item, and establish the first-type mapping relationship regarding the billing item, the generated comprehensive factor, and the pricing information of the given billing item for the group of values. In this way, when pricing the cloud product, the values of the impact factors of the target billing item of the to-be-valued product can be used to query the pricing information of the target billing item from the first-type mapping relationship, and use the queried pricing information to calculate the valuation fee of the to-be-valued product. It can be seen that since the solution not only considers the billing item itself, but also applies the impact of the impact factors of the billing item on the billing item to the pricing process to provide valuation basis for the valuation process when pricing, the degree of refinement in the valuation process can be improved through this pricing method, thereby the price competitiveness of the cloud product is improved.

Based on the content of the embodiment shown in FIG. 10, as shown in FIG. 11, a pricing method for a cloud product provided by the embodiment of the present application can include the following steps:

S1101: obtaining a billing item of a to-be-priced product, impact factors of the billing item, and the value ranges of the impact factors of the billing item, the impact factors of the billing item corresponding to the to-be-priced product, the impact factors of each target billing item of the to-be-priced product being the same;

S1102: obtaining pricing information of the billing item given by a first pricing staff for each group of values of the impact factors of the billing item;

S1103: generating, for each group of values of the impact factors of the billing item, a comprehensive factor corresponding to the billing item using the group of values, and establishing a first-type mapping relationship regarding the billing item, the generated comprehensive factor, and the pricing information of the given billing item for the group of values.

By generating the first-type mapping relationship, when valuing the cloud product, the values of the impact factors of the target billing item of the to-be-valued product is used to query the pricing information of the target billing item from the first-type mapping relationship, and the queried pricing information is used to calculate a valuation fee of the to-be-valued product.

In step S1101, there are one or more billing items of the to-be-priced product. Each billing item has impact factors, and each billing item can have one or more impact factors. In addition, the impact factors of the billing item corresponds to the product. In other words, each billing item of each product corresponds to the same impact factor.

In addition, there are multiple specific implementation of obtaining the billing item of the to-be-priced product, the impact factors of the billing item, and the value ranges of the impact factors of the billing item.

Exemplarily, in an implementation, multiple types of mapping relationship are established in advance. The multiple types of mapping relationship can be stored in different databases, or the same database. Specifically, the multiple types of mapping relationship are as follows: a second-type mapping relationship regarding identifiers of the products and billing items of the products; a fifth-type mapping relationship regarding identifiers of products and impact factors; and a fourth-type mapping relationship regarding configuration items and value ranges.

Wherein, the related description regarding the second-type mapping relationship, the fifth-type mapping relationship and the fourth-type mapping relationship refers to the description of the above-mentioned embodiments, which will not be repeated here.

Based on the multiple types of mapping relationship, obtaining the billing item of the to-be-priced product, the impact factors of the billing item, and the value ranges of the impact factors of the billing item can include:

querying the billing item of the to-be-priced product from the preset second-type mapping relationship regarding identifiers of the products and billing items of the products using an identifier of the to-be-priced product;

querying impact factors corresponding to the identifier of the to-be-priced product from the preset fifth-type mapping relationship regarding identifiers of products and impact factors, and taking as the impact factors of the billing item;

querying the value ranges of the impact factors of the billing item from the preset fourth-type mapping relationship regarding configuration items and value ranges.

In this implementation, the first pricing staff can specify an identifier of the to-be-priced product to a pricing apparatus, thus the pricing apparatus can use the identifier of the to-be-priced product as a query basis to query the second-type mapping relationship, the fifth-type mapping relationship and the fourth-type mapping relationship to obtain the billing item of the to-be-priced product, the impact factors of the billing item, and the value ranges of the impact factors of the billing item.

The above-mentioned specific implementation of obtaining the billing item of the to-be-priced product, the impact factors of the billing item, and the value ranges of the impact factors of the billing item is merely as an example, and should not constitute a limitation to the embodiments of the present application.

In this embodiment, steps S1102-S1103 are the same as steps S302-S303 in the embodiment shown in FIG. 3, which will not be repeated here.

In addition, for the solution in which the second-type mapping, the fifth-type mapping relationship, and the fourth-type mapping relationship exist, before obtaining the billing item of the to-be-priced product, the impact factors of the billing item, and the value ranges of the impact factors of the billing item, the pricing method for the cloud product can also include:

obtaining an identifier of the product and a specified billing item for the product given by a second pricing staff, and generating the second-type mapping regarding the given identifier of the product and the specified billing item;

obtaining the identifier of the product and specified impact factors for the product given by the second pricing staff, and generating a fifth-type mapping relationship regarding the given identifier of the product and the specified impact factors; and obtaining a configuration item and a specified value range for the configuration item given by the second pricing staff, and generating a fourth-type mapping relationship regarding the given configuration item and the specified value range, the given configuration item comprising the specified impact factors.

For the second-type mapping relationship, the fifth-type mapping relationship and the fourth-type mapping relationship, the second pricing staff can specify the identifier of the product, the billing item of the product and the impact factors of the billing item of the product by the specified configuration interface, so that the pricing apparatus can obtain various information to generate various mapping.

It can be seen that since the solution not only considers the billing item itself, but also applies the impact of the impact factor of the billing item on the billing item to the pricing process to provide valuation basis for the valuation process when pricing, the degree of refinement in the valuation process can be improved through this pricing method, thereby the price competitiveness of the cloud product is improved. In addition, since the impact factor corresponds to the product, it can be avoided that each billing item of the product corresponds to an impact factor, thereby greatly reducing the cost of data maintenance.

In addition, the embodiment of the present application also provides a valuation system for a cloud product. As shown in FIG. 4, the valuation system for the cloud product can include a pricing apparatus 410 and a valuation apparatus 420;

the pricing apparatus 410 is configured for obtaining a billing item of a to-be-priced product, impact factors of the billing item, and the value ranges of the impact factors of the billing item, the impact factors of the billing item correspond to the billing item; obtaining pricing information of the billing item given by a first pricing staff for each group of values of the impact factors of the billing item; and generating, for each group of values of the impact factors of the billing item, a comprehensive factor corresponding to the billing item using the group of values and establishing a first-type mapping relationship regarding the billing item, the generated comprehensive factor, and the pricing information of the given billing item for the group of values; the valuation apparatus 420 is configured for obtaining a value of the target billing item of the to-be-valued product and the values of the impact factors of the target billing item, the impact factors of the target billing item correspond to the target billing item; determining a comprehensive factor corresponding to the target billing item using the values of the impact factors of the target billing item; querying, according to the comprehensive factor corresponding to the target billing item, pricing information of the target billing item from a preset first-type mapping regarding billing items, comprehensive factors, and pricing information; and calculating a valuation fee for the to-be-valued product using the value and pricing information of the target billing item.

The system provided by the embodiment of the present application not only considers the billing item itself, but also applies the impact of the impact factors of the billing item on the billing item to the pricing process to provide valuation basis for the valuation process when pricing, so that not only considers the billing item itself, but also applies the impact of the impact factors of the billing item on the billing item to the valuation when valuing. It can be seen that the degree of refinement in the valuation process can be improved through this system, thereby the price competitiveness of the cloud product is improved.

Optionally, the valuation apparatus 420 determines a comprehensive factor corresponding to the target billing item using the values of the impact factors of the target billing item, which can include performing fusion processing on the values of the impact factors of the target billing item according to a predetermined fusion manner to obtain the comprehensive factor corresponding to the target billing item.

Optionally, the valuation apparatus 420 performs the fusion processing on the values of the impact factors of the target billing item according to the predetermined fusion manner to obtain the comprehensive factor corresponding to the target billing item, which can include sorting the values of the impact factors of the billing item according to the predetermined sorting manner, and performing splicing processing on the sorted values to obtain the spliced data; and performing signature calculation on the spliced data according to a predetermined signature algorithm to obtain the signature data as the comprehensive factor corresponding to the billing item.

Optionally, the way of determining the value of the target billing item of the to-be-valued product and values of the impact factors of the target billing item can include determining the target billing item of the to-be-valued product from the preset second-type mapping relationship regarding identifiers of the products and billing items of the products using an identifier of the to-be-valued product; determining the impact factors of the target billing item from the preset third-type mapping relationship regarding billing items and impact factors; taking a value of a configuration item that is the same as the target billing item among the multiple configuration items of the to-be-valued product as the value of the target billing item; and taking values of configuration items that are the same as impact factors of the target billing item among the multiple configuration items of the to-be-valued product as the values of the impact factors of the target billing item.

Optionally, the impact factors of the target billing item corresponds to the to-be-valued product, and the impact factors of each target billing item of the to-be-valued product are the same.

Optionally, if the impact factors of the target billing item correspond to the to-be-valued product and the impact factors of each target billing item of the to-be-valued product are the same, the way of determining the value of the target billing item of the to-be-valued product and the values of the impact factors of the target billing item includes using the identifier of the to-be-valued product to determine the target billing item of the to-be-valued product from the preset second-type mapping regarding identifiers of the products and billing items of the products; determining impact factors corresponding to the identifier of the to-be-valued product as the impact factors of the target billing item from the preset fifth-type mapping relationship regarding identifiers of products and impact factors; taking a value of a configuration item that is the same as the target billing item among the multiple configuration items of the to-be-valued product as the value of the target billing item; taking values of configuration items that are the same as the impact factors of the target billing item among the multiple configuration items of the to-be-valued product as the values of the impact factors of the target billing item.

Optionally, the impact factors of the target billing item correspond to the to-be-valued product, and the impact factors of each target billing item of the to-be-valued product are the same. The valuation apparatus is further configured that the cloud product includes at least two to-be-valued products, and after the calculation of valuation fees for the to-be-valued products, the valuation fee of the cloud product is calculated according to the valuation fees of the to-be-valued products.

Optionally, for each group of values of the impact factors of the billing item, the pricing apparatus 410 generates a comprehensive factor corresponding to the billing item using the group of values, which can include performing the fusion processing on the group of values according to the predetermined fusion manner to obtain the comprehensive factor corresponding to the billing item for each group of values of the impact factors of the billing item.

Optionally, for each group of values of the impact factor of the billing item, the pricing apparatus 410 performs the fusion processing on the group of values according to the predetermined fusion manner to obtain the comprehensive factor corresponding to the billing item can include for each group of values of the impact factor of the billing item, sorting the values of the impact factors of the billing item according to the predetermined sorting manner, and performing the splicing processing on the sorted values to obtain the spliced data; and performing signature calculation on the spliced data according to the predetermined signature algorithm to obtain the signature data as the comprehensive factor corresponding to the billing item.

Optionally, the pricing apparatus 410 obtains the billing item of the to-be-priced product, the impact factors of the billing item, and the value ranges of the impact factors of the billing item, which can include querying the billing item of the to-be-priced product from the preset second-type mapping regarding identifiers of the products and billing items of the products using the identifier of the to-be-priced product; querying the impact factors of the billing item of the to-be-priced product from the preset third-type mapping relationship regarding billing items and impact factors; and querying the value ranges of the impact factors of the billing item from the preset fourth-type mapping relationship regarding configuration items and value ranges.

Optionally, the pricing apparatus 410 is further configured that before obtaining the billing item of the to-be-priced product, the impact factors of the billing item, and the value ranges of the impact factors of the billing item, the identifier of the product given by the second pricing staff and the specified billing item for the given product are obtained, and the second-type mapping regarding the given identifier of the product and the specified billing item is generated; the identifier of the product given by the second pricing staff and the specified impact factor for the given product are obtained, and the third-type mapping relationship regarding the identifier of the given product and the specified impact factor is generated; and the configuration item given by the second pricing staff and the specified value range for the given configuration item are obtained, and the fourth-type mapping relationship regarding the given configuration item and the specified value range, the given configuration item including the specified impact factor is generated.

Optionally, the pricing apparatus 410 is further configured that after obtaining the billing item of the to-be-priced product, the impact factors of the billing item, and the value ranges of the impact factors of the billing item, and before obtaining the pricing information of the billing item for each group of values of the impact factors of the billing item given by the first pricing staff, the pricing management interface is displayed, the pricing management interface including the billing item of the to-be-priced product, the impact factors of the billing item, and the value ranges of the impact factors of the billing item;

the pricing apparatus 410 obtains the pricing information of the billing item for each group of values of the impact factors of the billing item given by the first pricing staff, which can include obtaining the pricing information of the billing item for each group of values of the impact factors of the billing item given by the first pricing staff through the pricing management interface.

Optionally, the impact factors of the billing item correspond to the to-be-priced product, and the impact factors of each billing item of the to-be-priced product are the same.

Optionally, if the impact factors of the billing item correspond to the to-be-priced product, and the impact factors of each billing item of the to-be-priced product are the same, the pricing apparatus 410 obtains the billing item of the to-be-priced product, the impact factors of the billing item, and the value ranges of the impact factors of the billing item, which can include using the identifier of the to-be-priced product to query the billing item of the to-be-priced product from the preset second-type mapping regarding identifiers of the products and billing items of the products; querying impact factors corresponding to the identifier of the to-be-priced product from the preset fifth-type mapping relationship regarding identifiers of products and impact factors as the impact factors of the billing item; and querying the value ranges of the impact factors of the billing item from the preset fourth-type mapping relationship regarding configuration items and value ranges.

Optionally, if the impact factors of the billing item correspond to the to-be-priced product, and the impact factors of each billing item of the to-be-priced product are the same, the pricing apparatus 410 is further configured that before obtaining the billing item of the to-be-priced product, the impact factors of the billing item, and the value ranges of the impact factors of the billing item, the identifier of the product given by the second pricing staff and the specified billing item for the given product are obtained, and the second-type mapping regarding the given identifier of the product and the specified billing item is generated; the identifier of the product given by the second pricing staff and the specified impact factor for the given product are obtained, and the fifth-type mapping relationship regarding the identifier of the given product and the specified impact factor is generated; and the configuration item given by the second pricing staff and the specified value range for the given configuration item are obtained, and the fourth-type mapping relationship regarding the given configuration item and the specified value range is generated, the given configuration item including the specified impact factor.

In addition, optionally, in an implementation, as shown in FIG. 5, the system can further include an ordering platform 430 and a metering apparatus 440. The ordering platform 430 is configured for outputting the ordering interface of the to-be-valued product, and when the to-be-valued product is a prepaid product, when the user completes the order based on the ordering interface, the product order form of the to-be-valued product is reported to the valuation apparatus; when the to-be-valued product is a postpaid product, when the user completes the order based on the ordering interface, the information in the product order form of the to-be-valued product is reported to the metering apparatus. The metering apparatus 440 is configured for, after obtaining the information in the product order form of the to-be-valued product, at the end of each billing cycle, determine the to-be-billed instance of the resource of the to-be-valued product based on the obtained information, the to-be-billed instance of the resource including the values of multiple configuration items of the postpaid product and the actual use time of the product of the current billing cycle, the multiple configuration items of the postpaid product including the configuration items for which the user has specified the values when the postpaid product is ordered and the configuration items for which the user has not specified values.

Correspondingly, when the pricing apparatus determines the value of the target billing item of the to-be-valued product and the values of the impact factors of the target billing item, the pricing apparatus is specifically configured for determining the value of the target billing item of the to-be-valued product and the values of the impact factors of the target billing item based on the product order form when the to-be-valued product is a prepaid product; determining the value of the target billing item of the to-be-valued product and the values of the impact factors of the target billing item based on the to-be-billed instance of the resource determined by the metering apparatus when the to-be-valued product is a postpaid product.

Of course, the system can further include an inquiry apparatus, the inquiry apparatus configured for determining the value of the target billing item of the to-be-valued product and the values of the impact factors of the target billing item and reporting them to the valuation apparatus. Correspondingly, the metering apparatus and the ordering platform can communicate with the inquiry apparatus. Then the inquiry apparatus is specifically configured for determining the value of the target billing item of the to-be-valued product and the values of the impact factors of the target billing item based on the product order form when the to-be-valued product is a prepaid product; determining the value of the target billing item of the to-be-valued product and the values of the impact factors of the target billing item based on the to-be-billed instance of the resource determined by the metering apparatus when the to-be-valued product is a postpaid product.

It can be understood that the above-mentioned valuation apparatus, pricing apparatus, metering apparatus and inquiry apparatus can run in the same equipment or in different equipments, all of which are appropriate and reasonable. The above-mentioned ordering platform can be a client program applied to the user terminal. the related description regarding each step of each apparatus in the valuation system refers to the respective description of the above-mentioned valuation method and pricing method, which will not be repeated here.

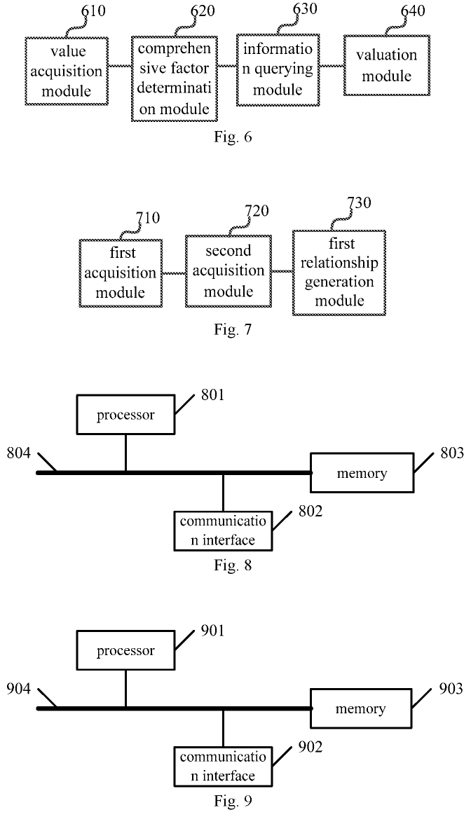

Corresponding to the embodiment of the above-mentioned valuation method, the embodiment of the present application provides a valuation apparatus for a cloud product. As shown in FIG. 6, the valuation apparatus includes a value acquisition module 610, configured for obtaining avalue of a target billing item of a to-be-valued product and values of impact factors of the target billing item, the impact factors of the target billing item correspond to the target billing item; a comprehensive factor determination module 620, configured for using the values of the impact factors of the target billing item to determine a comprehensive factor corresponding to the target billing item; an information querying module 630, configured for querying, according to the comprehensive factor corresponding to the target billing item, pricing information of the target billing item from a preset first-type mapping relationship regarding billing items, comprehensive factors, and pricing information; and a valuation module 640, configured for using the value and pricing information of the target billing item to calculate a valuation fee for the to-be-valued product.

It can be seen that since the solution not only considers the billing item itself, but also applies the impact of the impact factor of the billing item on the billing item to the valuation process to provide valuation basis for the valuation process when valuing, the degree of refinement in the valuation process can be improved through this valuation method, thereby the price competitiveness of the cloud product is improved.

Optionally, in an implementation, the comprehensive factor determination module 620 can include a first determining sub-module, configured for performing fusion processing on the values of the impact factors of the target billing item according to a predetermined fusion manner to obtain the comprehensive factor corresponding to the target billing item.

Optionally, the first determining sub-module is specifically configured for sorting the values of the impact factors of the target billing item according to a predetermined sorting manner, and performing splicing processing on the sorted values to obtain spliced data; and performing signature calculation on the spliced data according to a predetermined signature algorithm to obtain signature data as the comprehensive factor corresponding to the target billing item.

Optionally, the way of determining the value of the target billing item of the to-be-valued product and the values of the impact factors of the target billing item includes determining the target billing item of the to-be-valued product from the preset second-type mapping regarding identifiers of the products and billing items of the products using an identifier of the to-be-valued product; determining the impact factors of the target billing item from the preset third-type mapping relationship regarding billing items and impact factors; taking a value of a configuration item that is the same as the target billing item among multiple configuration items of the to-be-valued product as the value of the target billing item; and taking values of configuration items that are the same as the impact factors of the target billing item among the multiple configuration items of the to-be-valued product as the values of the impact factors of the target billing item.

Optionally, the impact factors of the target billing item corresponds to the to-be-valued product, and the impact factors of each target billing item of the to-be-valued product are the same.

Optionally, if the impact factors of the target billing item correspond to the to-be-valued product and the impact factors of each target billing item of the to-be-valued product are the same, the way of determining the value of the target billing item of the to-be-valued product and the values of the impact factors of the target billing item includes determining the target billing item of the to-be-valued product from the preset second-type mapping regarding identifiers of the products and billing items of the products using the identifier of the to-be-valued product; determining impact factors corresponding to the identifier of the to-be-valued product as the impact factors of the target billing item from the preset fifth-type mapping relationship regarding identifiers of products and impact factors; taking a value of a configuration item that is the same as the target billing item among multiple configuration items of the to-be-valued product as the value of the target billing item; and taking values of configuration items that are the same as the impact factors of the target billing item among the multiple configuration items of the to-be-valued product as the values of the impact factors of the target billing item.

Optionally, if the impact factors of the target billing item correspond to the to-be-valued product, and the impact factors of each target billing item of the to-be-valued product are the same, the cloud product includes at least two to-be-valued products, and the valuation module 640 is further configured for after the calculation of valuation fees for the to-be-valued products, calculating the valuation fee of the cloud product according to the valuation fees of the to-be-valued products.

Corresponding to the embodiment of the above-mentioned pricing method, the embodiment of the present application provides a pricing apparatus for a cloud product. As shown in FIG. 7, the pricing apparatus provided by the embodiment of the present application can include a first acquisition module 710, configured for obtaining a billing item of a to-be-priced product, impact factors of the billing item, and value ranges of the impact factors of the billing item, the impact factors of the billing item correspond to the billing item; a second acquisition module 720, configured for obtaining pricing information of the billing item for each group of values of the impact factors of the billing item given by a first pricing staff; and a first relationship generation module 730, configured for generating, for each group of values of the impact factors of the billing item, a comprehensive factor corresponding to the billing item using the group of values and establishing a first-type mapping relationship regarding the billing item, the generated comprehensive factor, and the pricing information of the billing item given for the group of values, such that when valuing the cloud product, the values of the impact factors of the target billing item of the to-be-valued product is used to query the pricing information of the target billing item from the first-type mapping relationship, and the queried pricing information is used to calculate the valuation fee of the to-be-valued product.

It can be seen that since the solution not only considers the billing item itself, but also applies the impact of the impact factor of the billing item on the billing item to the pricing process to provide valuation basis for the valuation process when pricing, the degree of refinement in the valuation process can be improved through this valuation method, thereby the price competitiveness of the cloud product is improved.

Optionally, for each group of values of the impact factors of the billing item, the first relationship generation module 730 generates the comprehensive factor corresponding to the billing item using the group of values, which can include performing fusion processing on the group of values according to a predetermined fusion manner to obtain the comprehensive factor corresponding to the billing item for each group of values of the impact factors of the billing item.

Optionally, for each group of values of the impact factors of the billing item, the first relationship generation module 730 performs the fusion processing on the group of values according to the predetermined fusion manner to obtain the comprehensive factor corresponding to the billing item can include for each group of values of the impact factors of the billing item, sorting the values of the impact factors of the billing item according to the predetermined sorting manner, and performing the splicing processing on the sorted values to obtain the spliced data; and performing signature calculation on the spliced data according to the predetermined signature algorithm to obtain the signature data as the comprehensive factor corresponding to the billing item.

Optionally, the first acquisition module 710 is specifically configured for querying the billing item of the to-be-priced product from the preset second-type mapping regarding identifiers of the products and billing items of the products using the identifier of the to-be-priced product; querying the impact factors of the billing item of the to-be-priced product from the preset third-type mapping relationship regarding billing items and impact factors; and querying the value ranges of the impact factors of the billing item from the preset fourth-type mapping relationship regarding configuration items and value ranges.

Optionally, a pricing apparatus for the cloud product provided by the embodiment of the present application can further include a configuration module, configured that before the first acquisition module obtains the billing item of the to-be-priced product, the impact factors of the billing item, and the value ranges of the impact factors of the billing item, the identifier of the product given by the second pricing staff and the specified billing item for the given product are obtained, and the second-type mapping relationship regarding the given identifier of the product and the specified billing item is generated; the identifier of the product given by the second pricing staff and the specified impact factor for the given product are obtained, and the third-type mapping relationship regarding the identifier of the given product and the specified impact factor is generated; and the configuration item given by the second pricing staff and the specified value range for the given configuration item are obtained, and the fourth-type mapping relationship regarding the given configuration item and the specified value range, the given configuration item including the specified impact factor is generated.

Optionally, the pricing apparatus for the cloud product provided by the embodiment of the present application can further include a display module, configured that after the first acquisition module 710 obtains the billing item of the to-be-priced product, the impact factors of the billing item, and the value ranges of the impact factors of the billing item, and before the second acquisition module 720 obtains the pricing information of the billing item for each group of values of the impact factors of the billing item given by the first pricing staff, the pricing management interface is displayed, the pricing management interface including the billing item of the to-be-priced product, the impact factors of the billing item, and the value ranges of the impact factors of the billing item. The second acquisition module 720 is specifically configured for obtaining the pricing information of the billing item for each group of values of the impact factors of the billing item given by the first pricing staff through the pricing management interface.

Optionally, the impact factors of the billing item correspond to the to-be-priced product, and the impact factors of each billing item of the to-be-priced product are the same.

Optionally, if the impact factors of the billing item correspond to the to-be-priced product, and the impact factors of each billing item of the to-be-priced product are the same, obtaining the billing item of the to-be-priced product, the impact factors of the billing item, and the value ranges of the impact factors of the billing item includes querying the billing item of the to-be-priced product from the preset second-type mapping regarding identifiers of the products and billing items of the products using the identifier of the to-be-priced product; querying impact factors corresponding to the identifier of the to-be-priced product from the preset fifth-type mapping relationship regarding identifiers of products and impact factors as the impact factors of the billing item; and querying the value ranges of the impact factors of the billing item from the preset fourth-type mapping relationship regarding configuration items and value ranges.

Optionally, if the impact factors of the billing item correspond to the to-be-priced product, and the impact factors of each billing item of the to-be-priced product are the same, the apparatus can further include a configuration module, configured that before the first acquisition module obtains the billing item of the to-be-priced product, the impact factors of the billing item, and the value ranges of the impact factors of the billing item, the identifier of the product given by the second pricing staff and the specified billing item for the given product are obtained, and the second-type mapping regarding the given identifier of the product and the specified billing item is generated; the identifier of the product given by the second pricing staff and the specified impact factor for the given product are obtained, and the fifth-type mapping relationship regarding the identifier of the given product and the specified impact factor is generated; and the configuration item given by the second pricing staff and the specified value range for the given configuration item are obtained, and the fourth-type mapping relationship regarding the given configuration item and the specified value range is generated, the given configuration item including the specified impact factor.

The embodiment of the present application also provides an electronic device, as shown in FIG. 8, including a processor 801, a communication interface 802, a memory 803, and a communication bus 804. Wherein, when the processor 801, the communication interface 802, and the memory 803 communicate with each other through the communication bus 804; the memory 803 is configured for storing computer programs; and the processor 801 is configured for executing the programs stored in the memory 803, the steps of the valuation method for the cloud product provided by the embodiment of the present application are implemented.

The embodiment of the present application also provides an electronic device, as shown in FIG. 9, including a processor 901, a communication interface 902, a memory 903, and a communication bus 904. Wherein, when the processor 901, the communication interface 902, and the memory 903 communicate with each other through the communication bus 904; the memory 903 is configured for storing computer programs; and the processor 901 is configured for executing the programs stored in the memory 903, the steps of the pricing method for the cloud product provided by the embodiment of the present application are implemented.

The communication bus mentioned in the above electronic device can be a Peripheral Component Interconnect (PCI) bus or an Extended Industry Standard Architecture (EISA) bus, etc. The communication bus can be divided into address bus, data bus, control bus and so on. For ease of representation, it is represented by only one thick line in the figure, but it does not mean that there is only one bus or one type of bus. The communication interface is used for communication between the above electronic device and other devices. The memory may include a Random Access Memory (RAM), and may also include a Non-Volatile Memory (NVM), such as at least one disk memory. Optionally, the memory may also be at least one storage device located far away from the above-mentioned processor. The above-mentioned processor may be a general-purpose processor, including a Central Processing Unit (CPU), a Network Processor (NP), etc.; it may also be a Digital Signal Processor (DSP), an Application Specific Integrated Circuit (ASIC), a Field-Programmable Gate Array (FPGA) or other programmable logic devices, discrete gates or transistor logic devices, discrete hardware components.

In another embodiment of the present application, a computer-readable storage medium is also provided. A computer program is stored in the computer-readable storage medium, the computer program implementing the above steps of the valuation method for the cloud product when executed by a processor.

In another embodiment of the present application, a computer-readable storage medium is also provided. A computer program is stored in the computer-readable storage medium, the computer program implementing the above steps of the pricing method for the cloud product when executed by a processor.

In another embodiment of the present application, a computer program product containing instructions is also provided, which causes a computer to execute the steps of the valuation method for the cloud product in the above embodiment when running on the computer.

In another embodiment of the present application, a computer program product containing instructions is also provided, which causes a computer to execute the steps of the pricing method for the cloud product in the above embodiment when running on the computer.

In another embodiment of the present application, a computer program is also provided, which causes a computer to execute the steps of the valuation method provided by the embodiment of the present application when running on the computer.

In another embodiment of the present application, a computer program is also provided, which causes a computer to execute the steps of the pricing method provided by the embodiment of the present application when running on the computer.

In the above-mentioned embodiments, it may be implemented entirely or partly by software, hardware, firmware, or any combination thereof. When implemented by software, it can be implemented in the form of a computer program product entirely or partly. The computer program product includes one or more computer instructions. When the computer program instructions are loaded and executed on the computer, the processes or functions described in the embodiments of the present application are generated entirely or partly. The computer may be a general-purpose computer, a special-purpose computer, a computer network, or other programmable devices. The computer instructions may be stored in the computer-readable storage medium, or transmitted from one computer-readable storage medium to another computer-readable storage medium. For example, the computer instructions may be transmitted from a website, computer, server, or data center to another website, computer, server or data center via wired (such as the coaxial cable, optical fiber, digital subscriber line (DSL)) or wireless (such as infrared, wireless, microwave). The computer-readable storage medium may be any available medium that can be accessed by the computer or a data storage device such as a server or data center integrated with one or more available media. The available medium may be a magnetic medium (for example, a floppy disk, a hard disk, a magnetic tape), an optical medium (for example, a DVD), or a semiconductor medium (for example, a Solid State Disk (SSD)).

The embodiments described above are simply preferable embodiments of the present application, and are not intended to limit the scope of protection of the present application. Any modifications, alternatives, improvements, or the like within the spirit and principle of the present application shall be included within the scope of protection of the present application.

### INDUSTRIAL APPLICABILITY

Since the valuation method, apparatus, device and storage medium provided by the present application not only consider the billing item itself, but also applies the impact of the impact factors of the billing item on the billing item to the valuation process when the valuation scheme valuing, the degree of refinement in the valuation process can be improved through the valuation scheme, thereby the price competitiveness of the cloud product is improved. In addition, since an impact factors corresponds to a product, it can be avoided that each billing item of a product corresponds to an impact factor, thereby greatly reducing the cost of data maintenance.

Since the pricing method, apparatus, device and storage medium provided by the present application not only consider the billing item itself, but also applies the impact of the impact factor of the billing item on the billing item to the pricing process to provide valuation basis for the valuation process when pricing, the degree of refinement in the valuation process can be improved through the valuation scheme, thereby the price competitiveness of the cloud product is improved. In addition, since the impact factor corresponds to the product, it can be avoided that each billing item of a product corresponds to an impact factor, thereby greatly reducing the cost of data maintenance.

What is claimed is:

1. A valuation method for a cloud product, the method comprising:
obtaining a value of a target billing item of a to-be-valued product and values of impact factors of the target billing item, the impact factors of the target billing item correspond to the target billing item;
determining a comprehensive factor corresponding to the target billing item using the values of the impact factors of the target billing item;
querying pricing information of the target billing item from a preset first-type mapping relationship regarding billing items, comprehensive factors, and pricing information according to the comprehensive factor corresponding to the target billing item; and
calculating a valuation fee for the to-be-valued product using the value and pricing information of the target billing item.

2. The method according to claim 1, wherein determining a comprehensive factor corresponding to the target billing item using the values of the impact factors of the target billing item comprises:
performing fusion processing on the values of the impact factors of the target billing item according to a predetermined fusion manner to obtain the comprehensive factor corresponding to the target billing item.

3. The method according to claim 2, wherein performing the fusion processing on the values of the impact factors of the target billing item according to a predetermined fusion manner to obtain the comprehensive factor corresponding to the target billing item comprises:
sorting the values of the impact factors of the target billing item according to a predetermined sorting manner, and performing splicing processing on the sorted values to obtain spliced data; and performing signature calculation on the spliced data according to a predetermined signature algorithm to obtain signature data as the comprehensive factor corresponding to the target billing item.

4. The method according to claim 1, wherein obtaining the value of target billing item of the to-be-valued product and values of impact factors of the target billing item comprises:
determining the target billing item of the to-be-valued product from a preset second-type mapping regarding identifiers of products and billing items of the products using an identifier of the to-be-valued product;
determining the impact factors of the target billing item from a preset third-type mapping relationship regarding billing items and impact factors;
taking a value of a configuration item that is the same as the target billing item among multiple configuration items of the to-be-valued product as the value of the target billing item; and
taking values of configuration items that are the same as the impact factors of the target billing item among the multiple configuration items of the to-be-valued product as the values of the impact factors of the target billing item.

5. The method according to claim 1, wherein the impact factors of the target billing item further correspond to the to-be-valued product, and the impact factors of each target billing item of the to-be-valued product are the same;
wherein obtaining the value of target billing item of the to-be-valued product and values of impact factors of the target billing items comprises:
determining the target billing item of the to-be-valued product from a preset second-type mapping relationship regarding identifiers of products and billing items of the products using the identifier of the to-be-valued product;
determining impact factors corresponding to the identifier of the to-be-valued product from a preset fifth-type mapping relationship regarding identifiers of products and impact factors, as the impact factors of the target billing item;
taking a value of a configuration item that is the same as the target billing item among multiple configuration items of the to-be-valued product as the value of the target billing item; and
taking values of configuration items that are the same as the impact factors of the target billing item among the multiple configuration items of the to-be-valued product as the values of the impact factors of the target billing item.

6. (canceled)

7. The method according to claim 5, wherein the cloud product comprises at least two to-be-valued products, and after calculating valuation fees of the to-be-valued products, the method comprises:
calculating valuation fee of the cloud product according to the valuation fees of the to-be-valued products.

8. A pricing method for a cloud product, the method comprising:
obtaining a billing item of a to-be-priced product, impact factors of the billing item, and value ranges of the impact factors of the billing item, wherein the impact factors of the billing item correspond to the billing item;
obtaining pricing information of the billing item given by a first pricing staff for each group of values of the impact factors of the billing item; and
generating, for each group of values of the impact factors of the billing item, a comprehensive factor corresponding to the billing item using the group of values, and establishing a first-type mapping relationship regarding the billing item, the generated comprehensive factor, and the pricing information of the billing item given for the group of values, such that when valuing the cloud product, the values of the impact factors of the target billing item of the to-be-valued product is used to query the pricing information of the target billing item from the first-type mapping relationship, and the queried pricing information is used to calculate the valuation fee of the to-be-valued product.

9. The method according to claim 8, wherein, generating, for each group of values of the impact factors of the billing item, the comprehensive factor corresponding to the billing item using the group of values, comprises:
for each group of values of the impact factors of the billing item, performing fusion processing on the group of values according to a predetermined fusion manner to obtain the comprehensive factor corresponding to the target billing item.

10. The method according to claim 9, wherein for each group of values of the impact factors of the billing item, performing fusion processing on the group of values according to a predetermined fusion manner to obtain the comprehensive factor corresponding to the target billing item comprises:
for each group of values of the impact factors of the billing item, sorting the value of the impact factors of the billing item according to a predetermined sorting manner, and performing splicing processing on the sorted values to obtain spliced data; and performing signature calculation on the spliced data according to a predetermined signature algorithm to obtain signature data as the comprehensive factor corresponding to the target billing item.

11. The method according to claim 8, wherein obtaining the billing item of the to-be-priced product, the impact factors of the billing item, and the value range of the impact factors of the billing item comprises:
querying a billing item of the to-be-priced product from a preset second-type mapping relationship regarding identifiers of the products and billing items of the products using an identifier of the to-be-priced product;
querying the impact factors of the billing item of the to-be-priced product from a preset third-type mapping relationship regarding billing items and impact factors; and
querying the value ranges of the impact factors of the billing item from a preset fourth-type mapping relationship regarding configuration items and value ranges.

12. The method according to claim 11, wherein before obtaining the billing item of the to-be-priced product, the impact factors of the billing item, and the value ranges of the impact factors of the billing item, the method further comprises:
obtaining an identifier of the product and a specified billing item for the product given by a second pricing staff, and generating a second-type mapping relationship regarding the given identifier of the product and the specified billing item;
obtaining a billing item and specified impact factors for the given billing item given by the second pricing staff, and generating a third-type mapping relationship regarding the given billing item and the specified impact factors; and
obtaining a configuration item and a specified value range for the given configuration item given by the second pricing staff, and generating a fourth-type mapping relationship regarding the given configuration item and the specified value range, the given configuration item comprising the specified impact factors.

13. The method according to claim 8, wherein after obtaining the billing item of the to-be-priced product, the impact factors of the billing item, and the value ranges of the impact factors of the billing item, and before obtaining pricing information of the billing item given by a first pricing staff for each group of values of the impact factors of the billing item, the method further comprises:
displaying a pricing management interface, the pricing management interface including the billing item of the to-be-priced product, the impact factors of the billing item, and the value ranges of the impact factors of the billing item;
obtaining the pricing information of the billing item given by the first pricing staff for each group of values of the impact factors of the billing item comprises:
obtaining the pricing information of the billing item given by the first pricing staff through the pricing management interface for each group of values of the impact factors of the billing item.

14. The method according to claim 8, wherein the impact factors of the billing item further correspond to the to-be-priced product, and the impact factors of each billing item of the to-be-priced product are the same.

15. The method according to claim 14, wherein obtaining the billing item of the to-be-priced product, the impact factors of the billing item, and the value ranges of the impact factors of the billing item comprises:
querying the billing item of the to-be-priced product from a preset second-type mapping relationship regarding identifiers of products and billing items of the products using an identifier of the to-be-priced product;
querying impact factors corresponding to the identifier of the to-be-priced product from a preset fifth-type mapping relationship regarding identifiers of products and impact factors as the impact factors of the billing item; and
querying the value ranges of the impact factors of the billing item from a preset fourth-type mapping relationship regarding configuration items and value ranges.

16. The method according to claim 15, wherein before obtaining the billing item of the to-be-priced product, the impact factors of the billing item, and the value ranges of the impact factors of the billing item, the method comprises:
obtaining an identifier of the product and a specified billing item for the product given by a second pricing staff, and generating the second-type mapping regarding the given identifier of the product and the specified billing item;
obtaining the identifier of the product and specified impact factors for the product given by the second pricing staff, and generating a fifth-type mapping relationship regarding the given identifier of the product and the specified impact factors; and
obtaining a configuration item and a specified value range for the configuration item given by the second pricing staff, and generating a fourth-type mapping relationship regarding the given configuration item and the specified value range, the given configuration item comprising the specified impact factors.

17. (canceled)

18. (canceled)

19. A valuation system for a cloud product, comprising: a pricing apparatus and a valuation apparatus;
the pricing apparatus is configured for obtaining a billing item of a to-be-priced product, impact factors of the billing item, and value ranges of the impact factors of the billing item, wherein the impact factors of the billing item correspond to the billing item; obtaining pricing information of the billing item given by a first pricing staff for each group of values of the impact factors of the billing item; and generating, for each group of values of the impact factors of the billing item, a comprehensive factor corresponding to the billing item using the group of values and establishing a first-type mapping relationship regarding the billing item, the generated comprehensive factor, and the pricing information of the billing item given for the group of values; and
the valuation apparatus is configured for obtaining a value of a target billing item of a to-be-valued product and values of impact factors of the target billing item, the impact factors of the target billing item correspond to the target billing item; determining a comprehensive factor corresponding to the target billing item using the values of the impact factors of the target billing item; querying, according to the comprehensive factor corresponding to the target billing item, pricing information of the target billing item from a preset first-type mapping relationship regarding billing items, comprehensive factors, and pricing information; and calculating a valuation fee for the to-be-valued product using the value and pricing information of the target billing item.

20. An electronic device, comprising: a processor, a communication interface, a memory, and a communication bus, wherein the processor, the communication interface, and the memory communicate with each other through the communication bus;
the memory is configured for storing computer programs; and
the processor is configured for implementing the steps of the method according to claim 1 when executing the programs stored in the memory.

21. A non-transitory computer-readable storage medium, in which a computer program stored, the computer program implementing the steps of the method according to claim 1 when executed by a processor.

22. (canceled)

23. (canceled)

24. An electronic device, comprising: a processor, a communication interface, a memory, and a communication bus, wherein the processor, the communication interface, and the memory communicate with each other through the communication bus;
the memory is configured for storing computer programs; and
the processor is configured for implementing the steps of the method according to claim 8 when executing the programs stored in the memory.

25. A non-transitory computer-readable storage medium, in which a computer program stored, the computer program implementing the steps of the method according to claim 8 when executed by a processor.
